(19) United States
(12) Patent Application Publication
(10) Pub. No.: US 2026/0247201 A1
(43) Pub. Date: Aug. 20, 2026

(54) METHOD BY WHICH TERMINAL COMMUNICATES IN WIRELESS COMMUNICATION SYSTEM AND DEVICE THEREFOR

(71) Applicant: LG Electronics Inc., Seoul (KR)

(72) Inventors: Seoyoung BACK, Seoul (KR); Seungmin LEE, Seoul (KR); Giwon PARK, Seoul (KR); Daesung HWANG, Seoul (KR)

(21) Appl. No.: 19/480,608

(22) PCT Filed: May 9, 2024
(86) PCT No.: PCT/KR2024/006271

§ 371 Date: Oct. 31, 2025

(30) Foreign Application Priority Data
May 9, 2023 (KR) 10-2023-0060062
Sep. 11, 2023 (KR) 10-2023-0120530

(51) Int. Cl. H04W 24/10; H04B 17/318

(52) U.S. Cl. CPC H04W 24/10; H04B 17/318

(57) ABSTRACT

A device receives configuration information for configuring a first threshold value for a direct path that directly connects to a base station and a second threshold value for an indirect Path that connects to the base station through a second terminal; and triggers the measurement report related to disconnection of the direct path on the basis of the first threshold value and the second threshold value.

### TECHNICAL FIELD

The present disclosure relates to a method and apparatus for triggering a measurement report for releasing a direct path at a user equipment (UE) for which multiple paths have been established in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### DISCLOSURE

### Technical Problem

The object of the present disclosure is to provide a method of performing relay communication more accurately and efficiently.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

### Technical Solution

According to an aspect, a method for triggering a measurement report by a first user equipment (UE) in a wireless communication system may include receiving configuration information configuring a first threshold for a direct path directly connected to a base station (BS) and a second threshold for an indirect path connected to the BS via a second UE, and triggering the measurement report related to release of the direct path based on the first threshold and the second threshold. The configuration information may set at least one of the first threshold or the second threshold differently based on a height of the first UE.

Alternatively, the measurement report may be triggered based on a signal strength of the direct path less than the first threshold and a signal strength of the indirect path greater than or equal to the second threshold.

Alternatively, the configuration information may set the first threshold to increase as the height of the first UE increases.

Alternatively, the configuration information may set the second threshold to decrease as the height of the first UE increases.

Alternatively, the measurement report may further include indication information indicating that the measurement report is for releasing the direct path without changing the direct path.

Alternatively, the method may further include receiving a message including a configuration for releasing the direct link.

Alternatively, the configuration information may further set at least one height range related to a measurement of the measurement report, and the measurement report may further include identification information about a height range where the measurement is performed among the at least one height range.

Alternatively, the measurement may be performed independently in each of the at least one height range.

Alternatively, the measurement information may be reported via the indirect path.

Alternatively, the first UE may be an unmanned aerial vehicle (UAV) remote UE, and the second UE may be a UAV relay UE.

According to another aspect, a computer-readable recording medium having recorded thereon a program for performing the method for triggering a measurement report may be provided.

According to another aspect, a first UE that performs the method for triggering a measurement report may be provided.

According to another aspect, a processing device for controlling a first UE that performs the method for triggering a measurement report may be provided.

According to another aspect, a method for receiving a measurement report from a first UE by a BS in a wireless communication system may include transmitting configuration information configuring a first threshold for a direct path directly connected to the first UE and a second threshold for an indirect path connected to the first UE via a second UE, and receiving the measurement report related to release of the direct path, triggered based on the first threshold and the second threshold. The configuration information may set at least one of the first threshold or the second threshold differently based on a height of the first UE.

According to another aspect, a BS that performs the method for receiving a measurement report from a first UE may be provided.

### Advantageous Effects

According to embodiments of the present disclosure, relay communication may be performed more accurately and efficiently in a wireless communication system.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

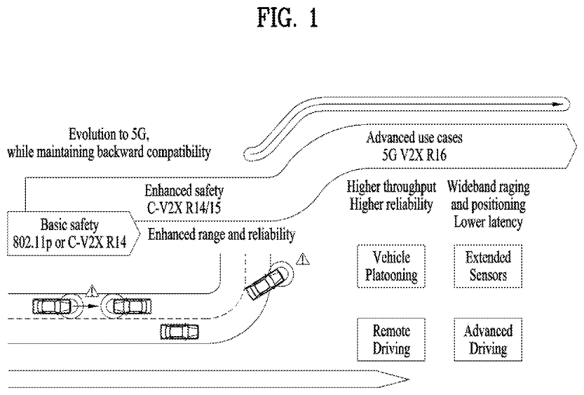

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a communication structure available in a sixth-generation (6G) system according to an embodiment of the present disclosure.

FIG. 7 illustrates an electromagnetic spectrum according to an embodiment of the present disclosure.

FIG. 8 illustrates a radio protocol architecture for SL communication.

FIG. 9 illustrates user equipments (UEs) performing V2X or SL communication.

FIG. 10 illustrates resource units for V2X or SL communication.

FIG. 11 shows an example of a BWP, based on an embodiment of the present disclosure.

FIG. 12 illustrates a procedure in which UEs perform V2X or SL communication according to a transmission mode.

FIG. 13 illustrates a procedure for path switching from a direct path to an indirect path.

FIG. 14 schematically illustrates a method of switching from a direct path to an indirect path.

FIGS. 15 and 16 are diagrams for explaining a procedure for UE-to-UE (U2U) relay selection without relay discovery.

FIG. 17 schematically illustrates plane protocol stacks for a L2 U2U relay.

FIGS. 18 to 22 are diagrams illustrating a U2X system.

FIG. 23 is a diagram illustrating connections among a UAV remote UE, a UAV relay UE, and a gNB.

FIG. 24 is a diagram illustrating a method for triggering a measurement report by a first UE.

FIG. 25 is a diagram illustrating a method for receiving a measurement report from a first UE by a BS.

FIG. 26 illustrates a communication system applied to the present disclosure.

FIG. 27 illustrates wireless devices applicable to the present disclosure.

FIG. 28 illustrates another example of a wireless device to which the present disclosure is applied. Wireless devices can be implemented in various forms depending on the use case/service.

FIG. 29 illustrates a vehicle or an autonomous driving vehicle applied to the present disclosure.

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto.

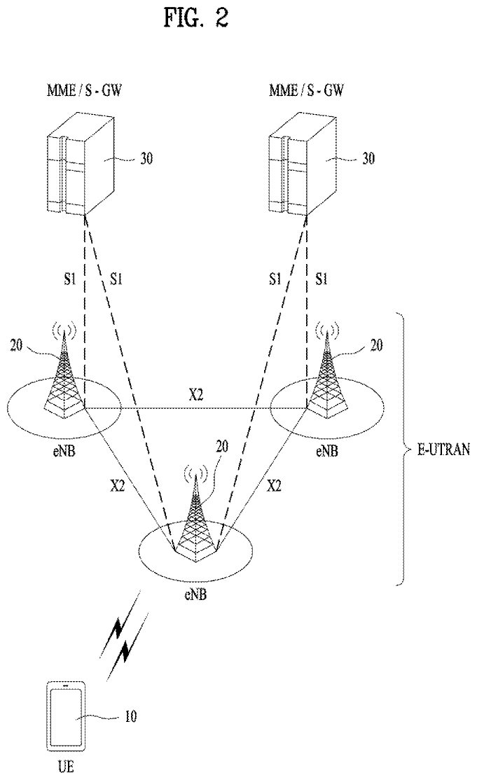

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2), and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

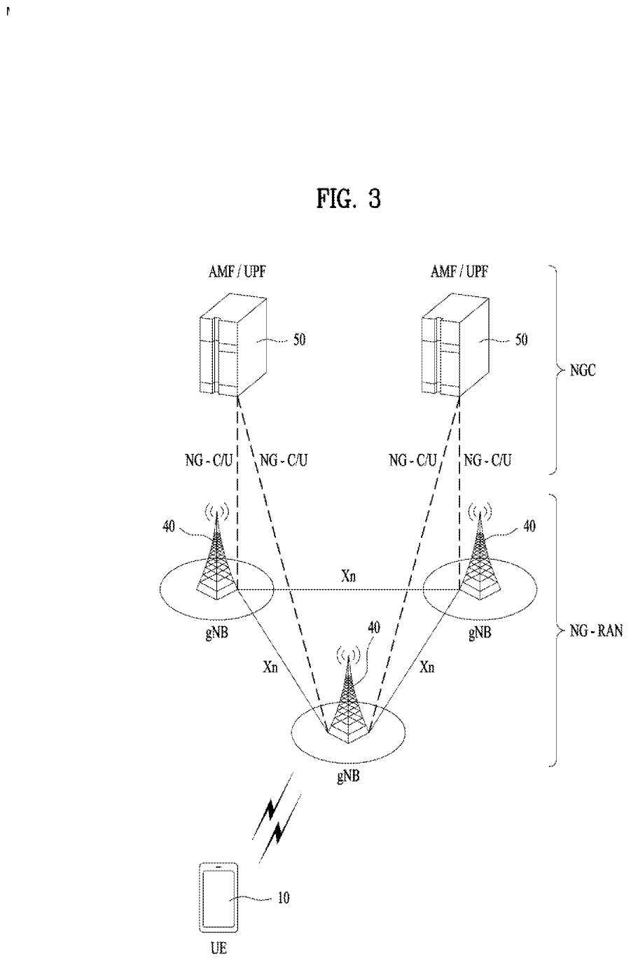

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

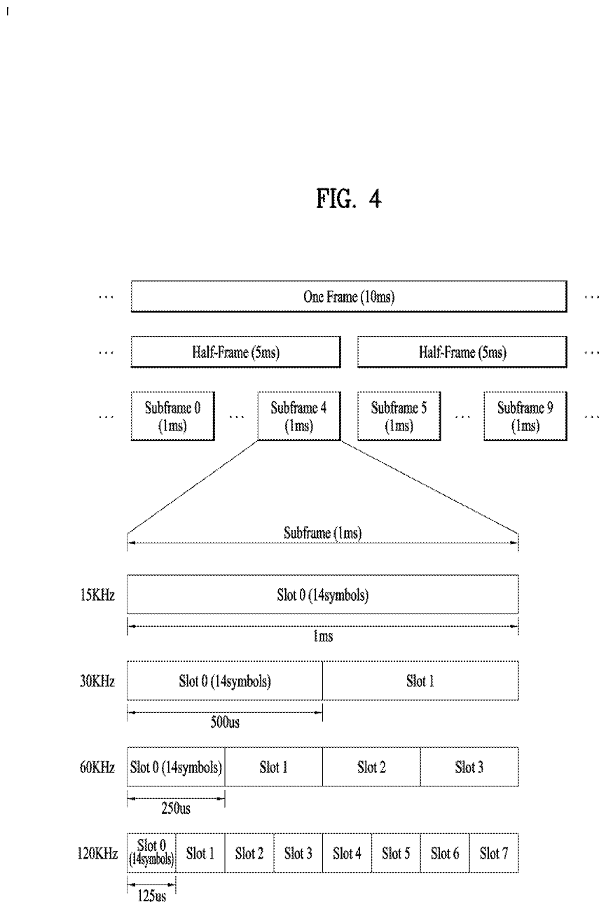

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration u in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

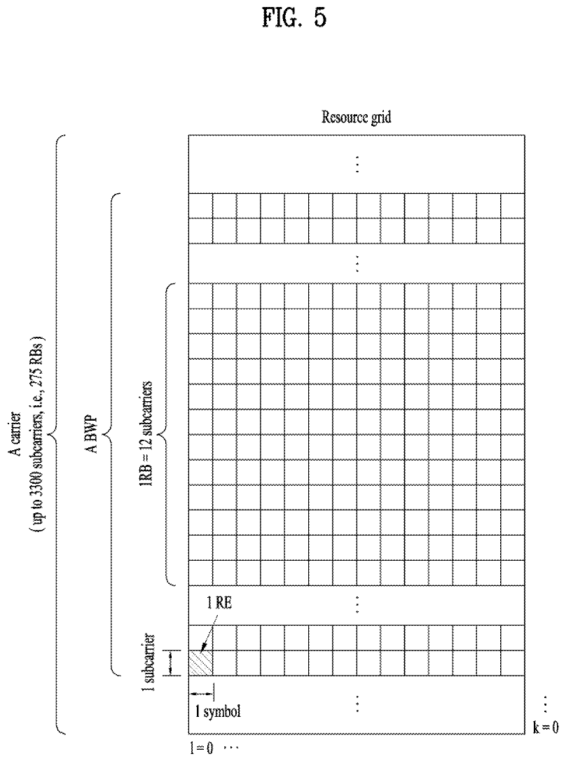

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

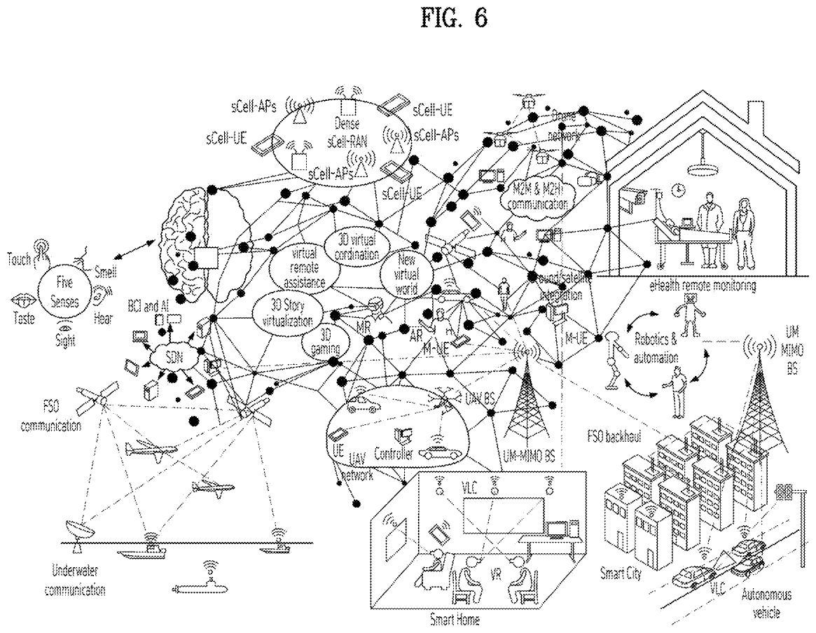

FIG. 6 illustrates a communication structure available in a sixth-generation (6G) system according to an embodiment of the present disclosure. The embodiment of FIG. 6 may be combined with various embodiments of the present disclosure.

In 6G, new network features may include the following.
Integrated satellite network
Connected intelligence: In contrast to previous generations of wireless communication systems, 6G may update the wireless advancement from “connected things” to “connected intelligence”. Artificial intelligence (AI) may be applied in each step of communication procedures (i.e., each step of signal processing to be described later).
Seamless integration of wireless information and energy transfer
Ubiquitous super three-dimensional (3D) connectivity: Access to networks and core network functions pm drones and very low earth orbit satellites may enable super 3D connectivity in 6G universal.

Regarding the new network feature of 6G as described above, several common requirements may include the following:
Small cell networks
Ultra-dense heterogeneous networks
High-capacity backhaul
Radar technology integrated with mobile technology: High-accuracy localization via communication (or location-based service) is one of the functionalities of the 6G wireless communication system. Therefore, radar systems will be integrated with the 6G network.

### Softwarization and Virtualization

Hereinafter, the key implementation technologies of the 6G system will be described.
Artificial intelligence (AI): Introducing AI into communication may simplify and enhance real-time data transmission. AI may determine how complex tasks are performed using numerous analyses. In other words, AI may increase efficiency and reduce processing delays. Time-consuming tasks such as handover, network selection, and resource scheduling may be performed instantly with the use of AI. AI may also play a crucial role in machine-to-machine (M2M), machine-to-human, and human-to-machine communication. In addition, AI may enable rapid communication in a brain-computer interface (BCI). AI-based communication systems may be supported by metamaterials, intelligent architectures, intelligent networks, intelligent devices, intelligent recognition radios, self-sustaining wireless networks, and machine learning.
Terahertz (THz) communication: Increasing the bandwidth may enhance data transmission rates, which may be achieved by using sub-THz communication with wide bandwidths and applying the advanced massive multiple input multiple output (MIMO) technology. THz waves, also known as submillimeter radiation, typically represent frequency bands between 0.1 THz and 10 THz, corresponding to wavelengths in the range of 0.03 mm to 3 mm. The band range from 100 GHz to 300 GHz (sub-THz band) is considered to be the main part of the THz band for cellular communications. Adding the sub-THz band to mmWave bands increases the capacity of 6G cellular communications. The band from 300 GHz to 3 THz of the defined THz band falls within the far infrared (IR) frequency band. The band from 300 GHz to 3 THz is part of the optical band, but the band lies at the boundary of the optical band and immediately after the RF band. Therefore, this 300 GHz to 3 THz band shows similarities to RF.

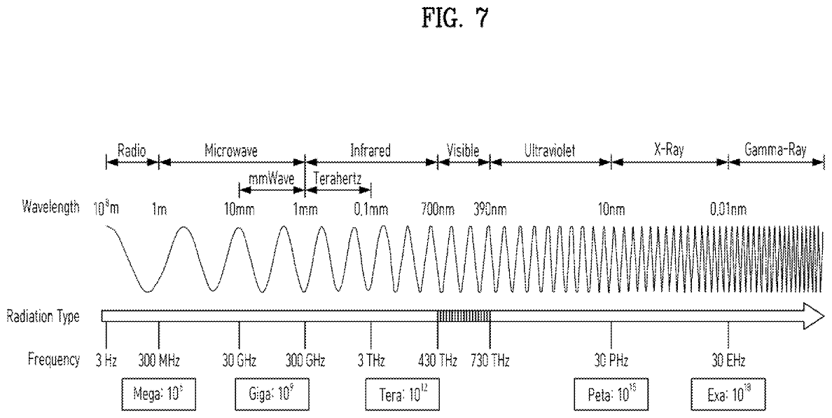

FIG. 7 illustrates an electromagnetic spectrum according to an embodiment of the present disclosure. The embodiment of FIG. 7 may be combined with various embodiments of the present disclosure. The key characteristics of THz communication include: (i) wide available bandwidths to support very high data transmission rates, and (ii) high path losses at high frequencies (highly directional antennas are indispensable). Narrow beamwidths generated by highly directional antennas reduce interference. The small wavelengths of THz signals allow a larger number of antenna elements to be incorporated into devices and BSs operating in this band. This enables the use of advanced adaptive array technologies capable of overcoming range limitations.
Large-scale MIMO technology
Hologram beamforming (HBF)
Optical wireless technology
Free-space optical (FSO) backhaul network
Quantum communication
Cell-free communication
Integration of wireless information and power transmission
Integration of wireless communication and sensing
Integrated access and backhaul network
Big data analysis
Reconfigurable intelligent surface
Metaverse
Blockchain
Unmanned aerial vehicle (UAV): UAVs or drones will be crucial elements in 6G wireless communication. In many cases, high-data-rate wireless connectivity may be provided using the UAV technology. BS entities may be installed on UAVs to provide cellular connectivity. The UAV may possess specific capabilities not found in fixed BS infrastructure, such as easy deployment, robust line-of-sight links, and degrees of freedom with controlled mobility. During emergencies such as natural disasters, the deployment of terrestrial communication infrastructure may not be economically feasible, and sometimes, it is impossible to provide services in volatile environments. The UAV may easily handle such situations. The UAV will represent a new paradigm in wireless communication. This technology facilitates the three fundamental requirements of wireless networks: enhanced mobile broadband (eMBB), ultra-reliable low latency communications (URLLC), and massive machine type communications (mMTC). In addition, the UAV may support various purposes such as improving network connectivity, fire detection, disaster emergency services, security and surveillance, pollution monitoring, parking monitoring, and accident monitoring. Therefore, the UAV technology is recognized as one of the most important technologies in 6G communication.
Autonomous driving (self-driving): Vehicle-to-everything (V2X) communication, a key element in establishing autonomous driving infrastructure, refers to a technology that allows vehicles to communicate and share information with various elements on the road, such as vehicle-to-vehicle (V2V) and vehicle-to-infrastructure (V2I) wireless communications. To maximize the performance of autonomous driving and ensure high safety standards, fast transmission speeds and low-latency technologies are essential. In addition, autonomous driving in the future may involve actively intervening in vehicle operation and directly controlling vehicles in hazardous situations beyond just providing warnings or guidance messages to drivers. To accommodate the vast amount of information that needs to be transmitted and received, it is expected in 6G that autonomous driving capabilities will be maximized with faster transmission speeds and lower latency compared to 5G.

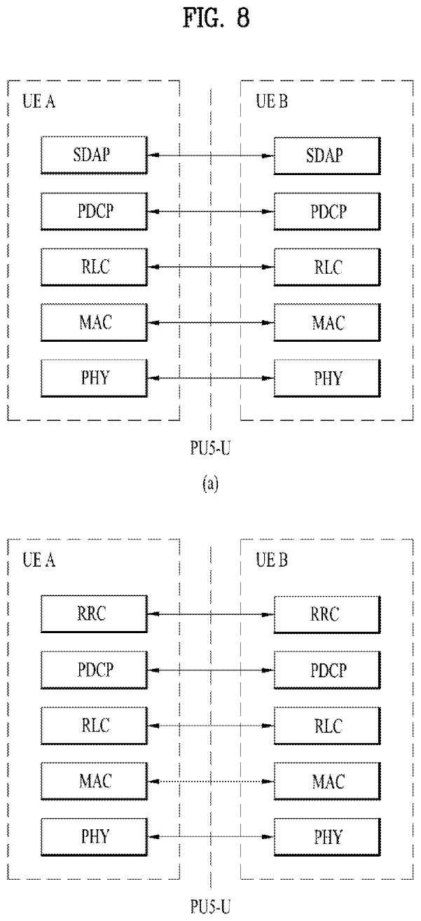

FIG. 8 illustrates a radio protocol architecture for SL communication. Specifically, FIG. 8-(a) shows a user plane protocol stack of NR, and FIG. 8-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

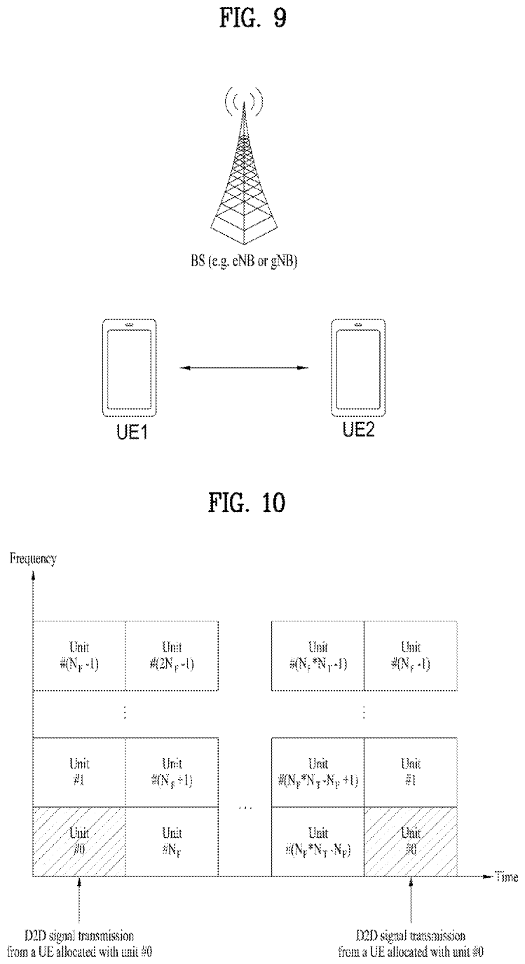

FIG. 9 illustrates UEs performing V2X or SL communication.

Referring to FIG. 9, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

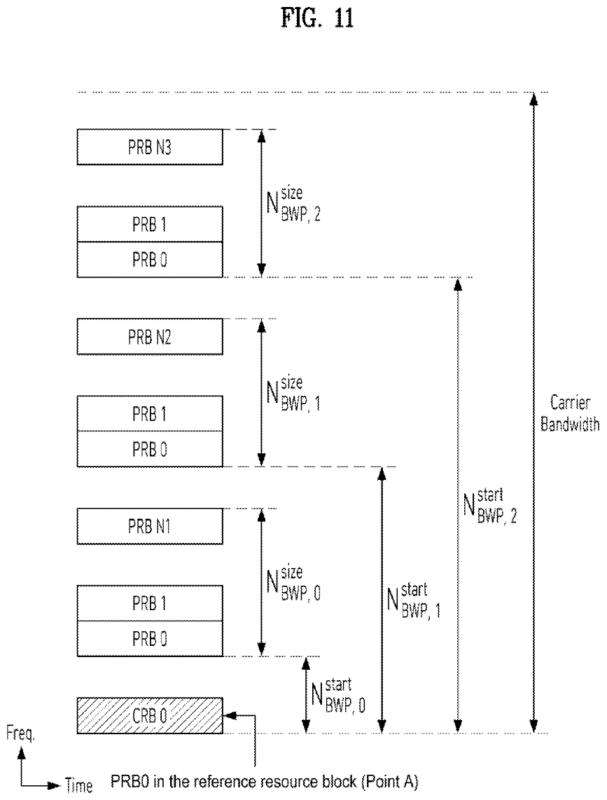

FIG. 10 illustrates resource units for V2X or SL communication.

Referring to FIG. 10, the frequency resources of a resource pool may be divided into N_{F} sets, and the time resources of the resource pool may be divided into N_{T} sets. Accordingly, a total of N_{F}*N_{T} resource units may be defined in the resource pool. FIG. 10 shows an exemplary case where the resource pool is repeated with a periodicity of NT subframes.

As shown in FIG. 10, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

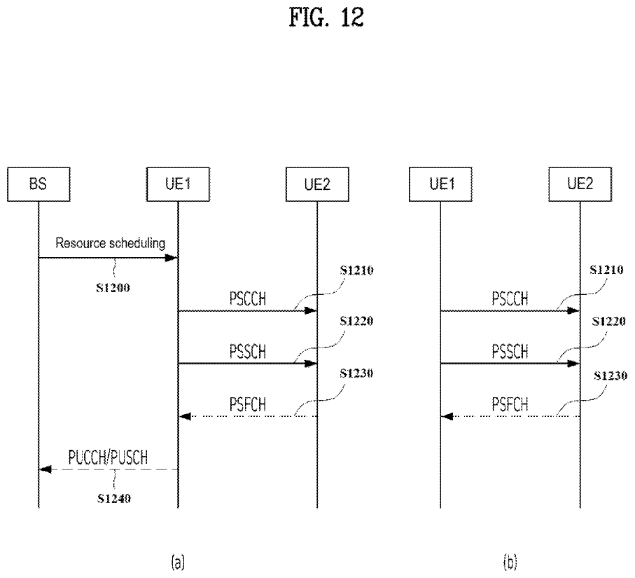

FIG. 11 shows an example of a BWP, based on an embodiment of the present disclosure. The embodiment of FIG. 11 may be combined with various embodiments of the present disclosure. It is assumed in the embodiment of FIG. 11 that the number of BWPs is 3.

Referring to FIG. 11, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described. The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

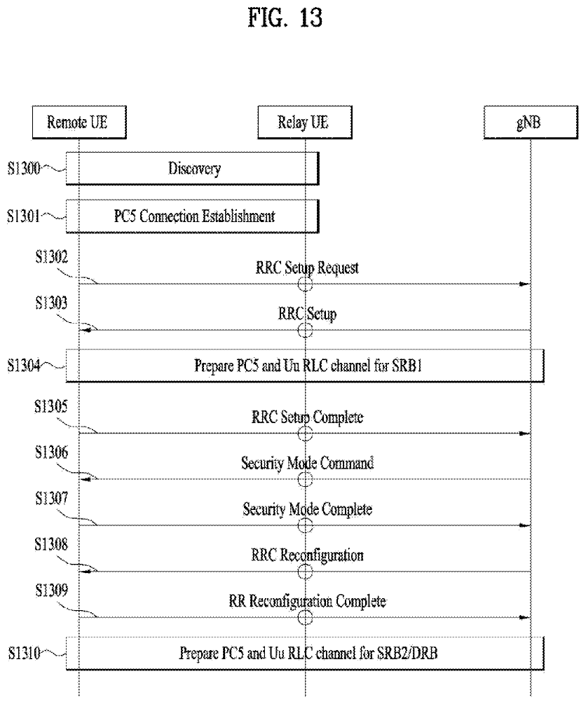

FIG. 12 illustrates a procedure for a terminal to perform V2X or SL communications in accordance with a resource allocation mode, according to one embodiment of the present disclosure. The embodiment of FIG. 12 may be combined with various embodiments of the present disclosure.

Referring to FIG. 12-(a), in LTE transmission mode 1, LTE transmission mode 3 or NR resource allocation mode 1, the BS may schedule an SL resource to be used by the UE for SL transmission. For example, in step S1200, the base station may transmit to the first terminal information associated with the SL resource and/or information associated with the UL resource. For example, the UL resource may include a PUCH resource and/or a PUSCH resource. For example, the UL resource may be a resource for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

In step S1210, the first UE may transmit a PSCCH (e.g., sidelink control information (SCI) or 1st-stage SCI) to a second UE based on the resource scheduling. In step S1220, the first UE may transmit a PSSCH (e.g., 2nd-stage SCI, MAC PDU, data, etc.) related to the PSCCH to the second UE. In step S1530, the first UE may receive a PSFCH related to the PSCCH/PSSCH from the second UE. For example, HARQ feedback information (e.g., NACK information or ACK information) may be received from the second UE through the PSFCH. In step S1540, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling.

Referring to (b) of FIG. 12, in the LTE transmission mode 2, the LTE transmission mode 4, or the NR resource allocation mode 2, a UE may determine SL transmission resource(s) within SL resource(s) configured by a base station/network or pre-configured SL resource(s). For example, the configured SL resource(s) or the pre-configured SL resource(s) may be a resource pool. For example, the UE may autonomously select or schedule resource(s) for SL transmission. For example, the UE may perform SL communication by autonomously selecting resource(s) within the configured resource pool. For example, the UE may autonomously select resource(s) within a selection window by performing a sensing procedure and a resource (re) selection procedure. For example, the sensing may be performed in a unit of subchannel(s). For example, in step S1210, a first UE which has selected resource(s) from a resource pool by itself may transmit a PSCCH (e.g., sidelink control information (SCI) or 1st-stage SCI) to a second UE by using the resource(s). In step S1220, the first UE may transmit a PSSCH (e.g., 2nd-stage SCI, MAC PDU, data, etc.) related to the PSCCH to the second UE. In step S1230, the first UE may receive a PSFCH related to the PSCCH/PSSCH from the second UE.

Referring to (a) or (b) of FIG. 12, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1st SCI, a first SCI, a 1st-stage SCI or a 1st-stage SCI format, and a SCI transmitted through a PSSCH may be referred to as a 2nd SCI, a second SCI, a 2nd-stage SCI, or a 2nd-stage SCI format.

Referring to (a) or (b) of FIG. 12, at step S1530, the first terminal may receive the PSFCH. For example, the first terminal and the second terminal may determine a PSFCH resource, and the second terminal may use the PSFCH resource to transmit HARQ feedback to the first terminal.

Referring to (a) of FIG. 12, at step S1540, the first terminal may transmit the SL HARQ feedback to the base station via PUCCH and/or PUSCH.

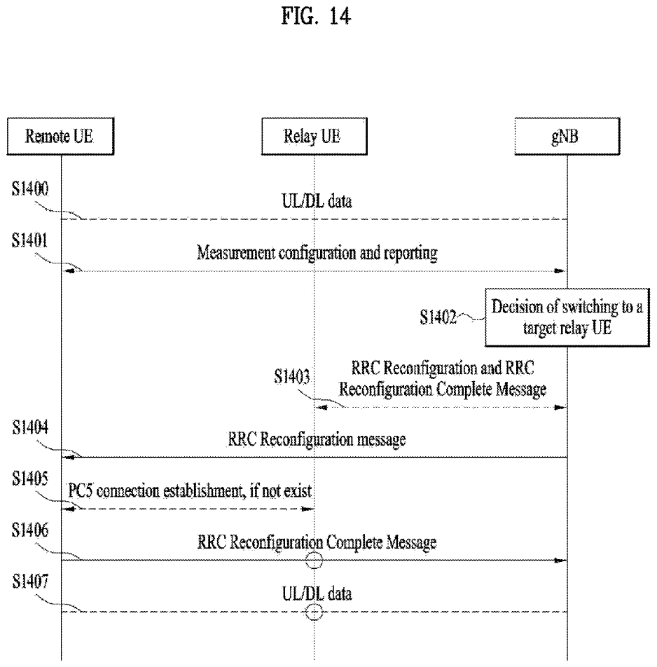

FIG. 13 illustrates a procedure for path switching from a direct path to an indirect path.

The procedure shown in FIG. 13 is based on the connection management and the path switching procedure from a direct path to an indirect path described in the TR document (3GPP TR 38.836) related to Rel-17 NR SL. A remote UE needs to establish a protocol data unit (PDU) session/data radio bearer (DRB) thereof with a network before user plane data transmission.

Regarding PC5-RRC in Rel-16 NR V2X, a PC5 unicast link establishment procedure may be reused to setup a secure unicast link between the remote UE and a relay UE for Layer 2 UE-to-network (L2 U2N) relaying before the remote UE establishes a Uu RRC connection with the network through the relay UE.

When the remote UE initiates a first RRC message to establish a connection with the gNB for both in-coverage and out-of-coverage cases, the PC5 L2 configuration for transmission between the remote UE and the U2N relay UE may be based on the radio link control (RLC) and/or medium access control (MAC) configuration defined in the standard. To establish Uu signaling radio bearer 1/signaling radio bearer 2 (SRB1/SRB2) and DRBs, the remote UE follows the legacy Uu configuration procedure for L2 U2N relaying. The high-level connection establishment procedure shown in FIG. 13 is applied to L2 U2N relaying.

In step S1300, the remote UE and relay UE may perform a discovery procedure. In step S1301, the remote UE and relay UE may establish a PC5-RRC connection based on legacy Rel-16 procedures.

In step S1302, the remote UE may transmit the first RRC message (i.e., RRCSetupRequest) to establish the connection with the gNB through the relay UE using the default PC5 L2 configuration. The gNB responds to the remote UE with an RRCSetup message (S1303). The default PC5 configuration is used to transmit the RRCSetup message to the remote UE. If the relay UE has not started in the RRC CONNECTED state, the relay UE needs to establish the connection upon receiving a message about the default PC5 L2 configuration. Details for the relay UE to transmit the RRCSetupRequest/RRCSetup message to the remote UE may be discussed in the work item (WI) phase.

In step S1304, the gNB and relay UE perform a relay channel setup procedure over Uu. Depending on the configuration of the gNB, the relay/remote UE establishes an RLC channel for relaying SRB1 to the remote UE over PC5. This step prepares the relay channel for SRB1.

In step S1305, the SRB1 message (e.g., RRCSetupComplete message) from the remote UE is transmitted to the gNB through the relay UE on the SRB1 relaying channel over PC5. The remote UE establishes the RRC connection over Uu.

In step S1306, the remote UE and gNB establish security according to legacy procedures, and a security message is transmitted through the relay UE.

In steps S1308 and S1309, the gNB transmits an RRCReconfiguration message to the remote UE through the relay UE to establish the SRB2/DRB for relaying. The remote UE responds to the gNB with an RRCReconfigurationComplete message through the relay UE.

In step S1310, the gNB establishes an additional RLC channel between the gNB and relay UE for traffic relay. Depending on the configuration of the gNB, the relay/remote UE establishes additional RLC channels between the remote UE and relay UE for traffic relay. The gNB transmits the RRCReconfiguration message to the remote UE through the relay UE to establish the SRB2/DRB for relaying. The remote UE responds to the gNB with the RRCReconfigurationComplete message through the relay UE.

For L2 U2N relaying in addition to the connection establishment procedure:
The RRC reestablishment and RRC connection release procedures may reuse legacy RRC procedures along with the message content/configuration design left in the WI phase.
The RRC connection reestablishment and RRC connection resume procedures may reuse legacy RRC procedures as a baseline by considering the connection establishment procedure of the L2 U2N relay above to handle relay-specific parts along with message content/configuration design. The message content/configuration may be defined at a later stage.

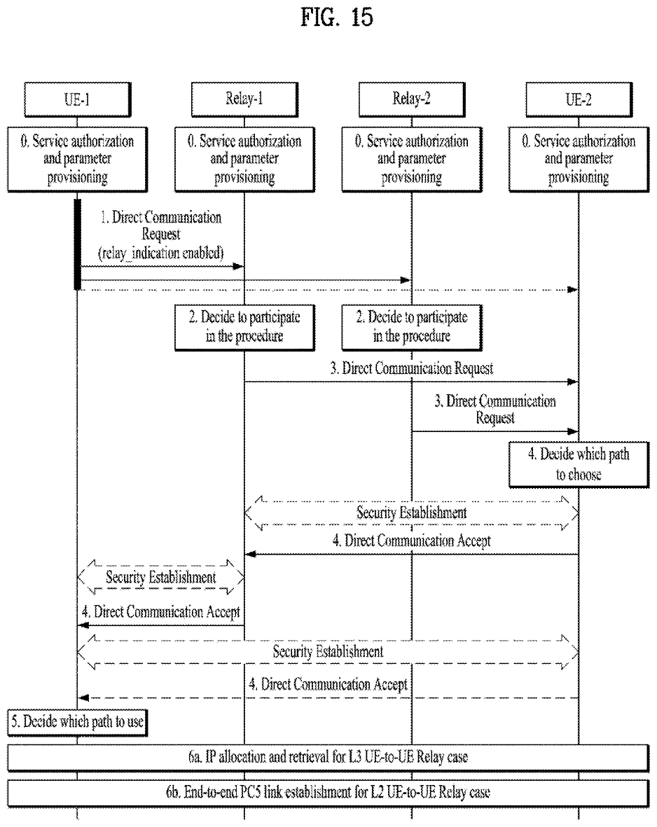

FIG. 14 schematically illustrates a method of switching from a direct path to an indirect path.

A direct remote UE may transition to an indirect relay UE for service continuity of the L2 U2N relay based on the procedure shown in FIG. 14.

Referring to FIG. 14, in step S1401, the remote UE may report one or several candidate relay UEs after measuring/discovering the candidate relay UEs. When reporting the candidate relay UEs, the remote UE may filter appropriate relay UEs that meet higher layer criteria. The report of the at least one candidate relay may include the ID of the relay UE and SL RSRP information. Details related to PC5 measurement may be determined later.

In step S1402, the gNB determines to switch to a target relay UE and optionally transmits a target (re)configuration to the relay UE (S1403).

In step S1404, an RRCReconfiguration message for the remote UE may include the ID of the target relay UE and target Uu and PC5 configurations.

In step S1405, the remote UE establishes a PC5 connection with the target relay UE if there is no connection established.

In step S1406, the remote UE feeds back an RRCReconfigurationComplete message to the gNB via a target path based on the target configuration provided in the RRCReconfiguration message.

In step S1407, the data path is switched.

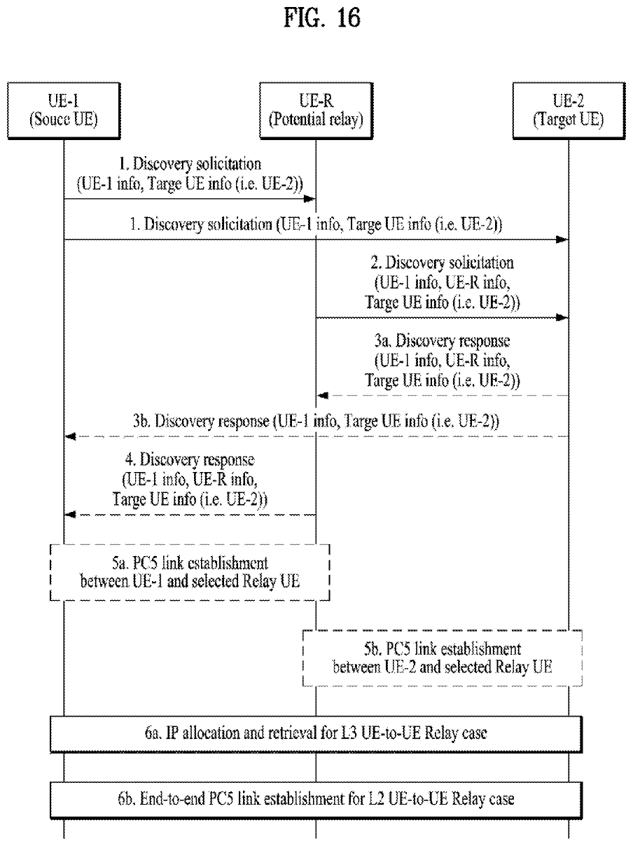

FIGS. 15 and 16 are diagrams for explaining a procedure for UE-to-UE (U2U) relay selection without relay discovery.

Referring to the specified scenario (in Clause 6.8 of TR 23.752), when a source UE desires to communicate with a target UE, the source UE may first attempt to find the target UE by transmitting a Direct Communication Request or Solicitation message including information about the target UE. If the source UE is incapable of directly reaching the target UE, the source UE may attempt to discover a U2U relay to reach the target UE which may also trigger the relay to discover the target UE. The source UE may integrate the discovery of the target UE and/or the discovery/selection of the U2U relay based on the following two alternatives.
Alternative 1: The discovery/selection of the U2U relay may be integrated into a unicast link establishment procedure (refer to Clause 6.3.3 of TS 23.287).
Alternative 2: The discovery/selection of the U2U relay may be integrated into a Model B direct discovery procedure.

To indicate whether a relay is capable of being used for communication, a new field may be added to the Direct Communication Request or Solicitation message. This new field may be defined as Relay_indication. If the (source) UE intends to broadcast the Direct Communication Request or Solicitation message, the request message may include Relay_indication to indicate whether the U2U relay may be used. For Release 17, it may be assumed that the value of Relay_indication is limited to a single hop.

If the U2U relay receives the request message with Relay_indication configured, the U2U relay may determine whether to forward the request message (i.e., modify the message and broadcast the message in the vicinity thereof). For instance, based on the following factors: Relay Service Code if present, Application ID, authorization policy (e.g., relay for specific ProSe services), current traffic load of the relay, and wireless conditions between the source UE and relay UE, the U2U relay may determine whether to forward the request message.

Alternatively, multiple U2U relays may be used to reach the target UE (scenario 1), or the target UE may directly receive the request message from the source UE (scenario 2). In this case, the target UE may select whether to respond in scenario 1 or scenario 2. For example, the target UE may select whether to respond in scenario 1 or scenario 2 based on the following factors: signal strength, local policy (e.g., traffic load of U2U relays), relay service code (if present), and/or operator policies (e.g., preference for always using direct communication or selectively using specific U2U relays).

Alternatively, the source UE may receive responses to the request message from multiple U2U relays or may directly receive a response to the request message from the target UE. In this case, the source UE may select the communication path (direct path or indirect path) based on the signal strength or operator policies (e.g., preference for always using direct communication or selectively using specific U2U relays).

Specifically, the alternative described above may be implemented as described in Table 5 and FIG. 15.

TABLE 5

| | |
|---|---|
| 6.8.2 | Procedures |
| 6.8.2.1 | UE-to-UE relay discovery and selection is integrated into the unicast link establishment |

procedure (Alternative 1)
FIG. 14 illustrates the procedure of the proposed method.

| | |
|---|---|
| 0. | UEs are authorized to use the service provided by the UE-to-UE relays. UE-to-UE |

relays are authorized to provide service of relaying traffic among UEs. The authorization and
the parameter provisioning can use solutions for KI#8, e.g. Sol#36. The authorization can be
done when UEs/relays are registered to the network. Security related parameters may be
provisioned so that a UE and a relay can verify the authorization with each other if needed.

| | |
|---|---|
| 1. | UE-1 wants to establish unicast communication with UE-2 and the communication can |

be either through direct link with UE-2 or via a UE-to-UE relay. Then UE-1 broadcasts Direct
Communication Request with relay indication enabled. The message will be received by relay-
1, relay-2. The message may also be received by UE-2 if it is in the proximity of UE-1. UE-1
includes source UE info, target UE info, Application ID, as well as Relay Service Code if there
is any. If UE-1 does not want relay to be involved in the communication, then it will made
relay_indication disabled.

| | |
|---|---|
| NOTE 1: | The data type of relay_indication can be determined in Stage 3. Details of Direct |

Communication Request/Accept messages will be determined in stage 3.

| | |
|---|---|
| 2. | Relay-1 and relay-2 decide to participate in the procedure. They broadcast a new Direct |

Communication Request message in their proximity without relay_indication enabled. If a relay
receives this message, it will just drop it. When a relay broadcasts the Direct Communication
Request message, it includes source UE info, target UE info and Relay UE info (e.g. Relay UE
ID) in the message and use Relay's L2 address as the source Layer-2 ID. The Relay maintains
association between the source UE information (e.g. source UE L2 ID) and the new Direct
Communication Request.

| | |
|---|---|
| 3. | UE-2 receives the Direct Communication Requests from relay-1 and relay-2. UE-2 may |

also receive Direct Communication Request message directly from the UE-1 if the UE-2 is in
the communication range of UE-1.

| | |
|---|---|
| 4. | UE-2 chooses relay-1 and replies with Direct Communication Accept message. If UE-2 |

directly receives the Direct Communication Request from UE-1, it may choose to setup a direct
communication link by sending the Direct Communication Accept message directly to UE-1.
After receiving Direct Communication Accept, a UE-to-UE relay retrieves the source UE
information stored in step 2 and sends the Direct Communication Accept message to the source
UE with its Relay UE info added in the message.
After step 4, UE-1 and UE-2 have respectively setup the PC5 links with the chosen UE-to-UE
relay.

| | |
|---|---|
| NOTE 2: | The security establishment between the UE1 and Relay-1, and between Relay-1 |

and UE-2 are performed before the Relay-1 and UE-2 send Direct Communication Accept
message. Details of the authentication/security establishment procedure are determined by SA
WG3. The security establishment procedure can be skipped if there already exists a PC5 link
between the source (or target) UE and the relay which can be used for relaying the traffic.

| | |
|---|---|
| 5. | UE-1 receives the Direct Communication Accept message from relay-1. UE-1 chooses |

path according to e.g. policies (e.g. always choose direct path if it is possible), signal strength,
etc. If UE-1 receives Direct Communication Accept/Response message request accept directly
from UE-2, it may choose to setup a direct PC5 L2 link with UE-2 as described in clause 6.3.3
of TS 23.287 [5], then step 6 is skipped.

| | |
|---|---|
| 6a. | For the L3 UE-to-UE Relay case, UE-1 and UE-2 finish setting up the communication |

link via the chosen UE-to-UE relay. The link setup information may vary depending on the type
of relay, e.g. L2 or L3 relaying. Then UE-1 and UE-2 can communicate via the relay. Regarding
IP address allocation for the source/remote UE, the addresses can be either assigned by the relay
or by the UE itself (e.g. link-local IP address) as defined in clause 6.3.3 of TS 23.287 [5].
6b. For the Layer 2 UE-to-UE Relay case, the source and target UE can setup an end-to-end
PC5 link via the relay. UE-1 sends a unicast E2E Direct Communication Request message to
UE-2 via the Relay-1, and UE-2 responds with a unicast E2E Direct Communication Accept
message to UE-1 via the Relay-1. Relay-1 transfers the messages based on the identity
information of UE-1/UE-2 in the Adaptation Layer.

| | |
|---|---|
| NOTE 3: | How Relay-1 can transfer the messages based on the identity information of UE- |

1/UE-2 in the Adaptation Layer requires cooperation with RAN2 during the normative phase.

| | |
|---|---|
| NOTE 4: | In order to make a relay or path selection, the source UE can setup a timer after |

sending out the Direct Communication Request for collecting the corresponding response
messages before making a decision. Similarly, the target UE can also setup a timer after
receiving the first copy of the Direct Communication Request/message for collecting multiple
copies of the message from different paths before making a decision.

| | |
|---|---|
| NOTE 5: | In the first time when a UE receives a message from a UE-to-UE relay, the UE |

needs to verify if the relay is authorized be a UE-to-UE relay. Similarly, the UE-to-UE relay
may also need to verify if the UE is authorized to use the relay service. The verification details
and the how to secure the communication between two UEs through a UE-to-UE relay is to be
defined by SA WG3.

Alternative 2 described above may be implemented as described in Table 6 and FIG. 16.

TABLE 6
6.8.2.2 UE-to-UE relay discovery and selection is integrated into Model B direct discovery
procedure (Alternative 2)
Depicted in FIG. 15 is the procedure for UE-UE Relay discovery Model B, and the
discovery/selection procedure is separated from hop by hop and end-to-end link establishment.

| | |
|---|---|
| 1. | UE-1 broadcasts discovery solicitation message carrying UE-1 info, target UE info (UE- |

2), Application ID, Relay Service Code if any, the UE-1 can also indicate relay_indication
enabled.

| | |
|---|---|
| 2. | On reception of discovery solicitation, the candidate Relay UE-R broadcasts discovery |

solicitation carrying UE-1 info, UE-R info, Target UE info. The Relay UE-R uses Relay's L2
address as the source Layer-2 ID.

| | |
|---|---|
| 3. | The target UE-2 responds the discovery message. If the UE-2 receives discovery |

solicitation message in step 1, then UE-2 responds discovery response in step 3b with UE-1 info,
UE-2 info. If not and UE-2 receives discovery solicitation in step 2, then UE-2 responds
discovery response message in step 3a with UE-1 info, UE-R info, UE-2 info.

| | |
|---|---|
| 4. | On reception of discovery response in step 3a, UE-R sends discovery response with UE-1 |

info, UE-R info, UE-2 info. If more than one candidate Relay UEs responding discovery
response message, UE-1 can select one Relay UE based on e.g. implementation or link
qualification.

| | |
|---|---|
| 5. | The source and target UE may need to setup PC5 links with the relay before |

communicating with each other. Step 5a can be skipped if there already exists a PC5 link
between the UE-1 and UE-R which can be used for relaying. Step 5b can be skipped if there
already exists a PC5 link between the UE-2 and UE-R which can be used for relaying.

| | |
|---|---|
| 6a. | Same as step 6a described in clause 6.8.2.1. |
| 6b. | For the Layer-2 UE-to-UE Relay, the E2E unicast Direct Communication Request |

message is sent from UE1 to the selected Relay via the per-hop link (established in steps 5a) and
the Adaptation layer info identifying the peer UE (UE3) as the destination. The UE-to-UE Relay
transfers the E2E messages based on the identity information of peer UE in the Adaptation
Layer. The initiator (UE1) knows the Adaptation layer info identifying the peer UE (UE3) after a
discovery procedure. UE3 responds with E2E unicast Direct Communication Accept message in
the same way.
NOTE 1: For the Layer 2 UE-to-UE Relay case, whether step5b is performed before step 6b or
triggered during step 6b will be decided at normative phase.
NOTE 2: How Relay-1 can transfer the messages based on the identity information of UE-1/UE-
2 in the Adaptation Layer requires cooperation with RAN2 during the normative phase.
6.8.3 Impacts on services, entities and interfaces
UE impacts to support new Relay related functions.

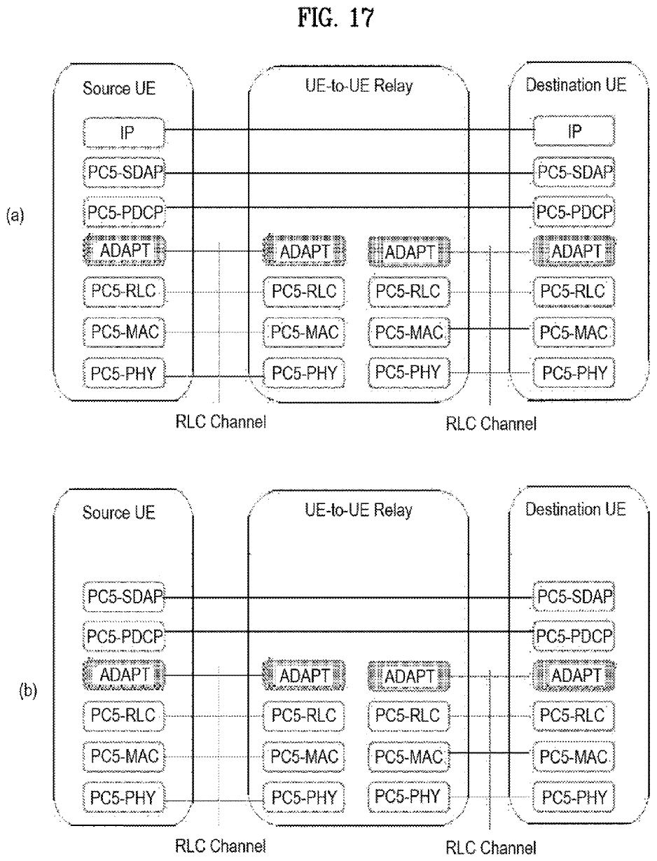

FIG. 17(a) schematically illustrates a protocol stack for an L2 U2U relay.

FIG. 17(a) illustrates a user plane protocol stack for the L2 U2U relay, while FIG. 17(b) illustrates a control plane protocol stack for the L2 U2U relay. Table 7 shows details of the architectures and protocol stacks of the L2 relay shown in FIG. 17.

TABLE 7

| | |
|---|---|
| 5.5 | Layer-2 Relay |
| 5.5.1 | Architecture and Protocol Stack |

For L2 UE-to-UE Relay architecture, the protocol stacks are similar to L2 UE-to-Network
Relay other than the fact that the termination points are two Remote UEs. The protocol stacks
for the user plane and control plane of L2 UE-to-UE Relay architecture are described in FIG.
5.5.1-1 and FIG. 5.5.1-2.
An adaptation layer is supported over the second PC5 link (i.e. the PC5 link between Relay
UE and Destination UE) for L2 UE-to-UE Relay. For L2 UE-to-UE Relay, the adaptation
layer is put over RLC sublayer for both CP and UP over the second PC5 link. The sidelink
SDAP/PDCP and RRC are terminated between two Remote UEs, while RLC, MAC and PHY
are terminated in each PC5 link.
For the first hop of L2 UE-to-UE Relay,

The N:1 mapping is supported by first hop PC5 adaptation layer between Remote UE

SL Radio Bearers and first hop PC5 RLC channels for relaying.

The adaptation layer over first PC5 hop between Source Remote UE and Relay UE

supports to identify traffic destined to different Destination Remote UEs.
For the second hop of L2 UE-to-UE Relay,

The second hop PC5 adaptation layer can be used to support bearer mapping between

the ingress RLC channels over first PC5 hop and egress RLC channels over second PC5 hop at
Relay UE.

PC5 Adaptation layer supports the N:1 bearer mapping between multiple ingress PC5

RLC channels over first PC5 hop and one egress PC5 RLC channel over second PC5 hop and
supports the Remote UE identification function.
For L2 UE-to-UE Relay,

The identity information of Remote UE end-to-end Radio Bearer is included in the

adaptation layer in first and second PC5 hop.

In addition, the identity information of Source Remote UE and/or the identity

information of Destination Remote UE are candidate information to be included in the
adaptation layer, which are to be decided in WI phase.

A detailed description will be given below of U2X for support of Broadcast Remote ID and direct Detect-and-Avoid (DAA) via PC5 (Refer to TR 23.700-58).

### Unmanned Aerial Vehicle (UAV)-to-Everything (U2X)

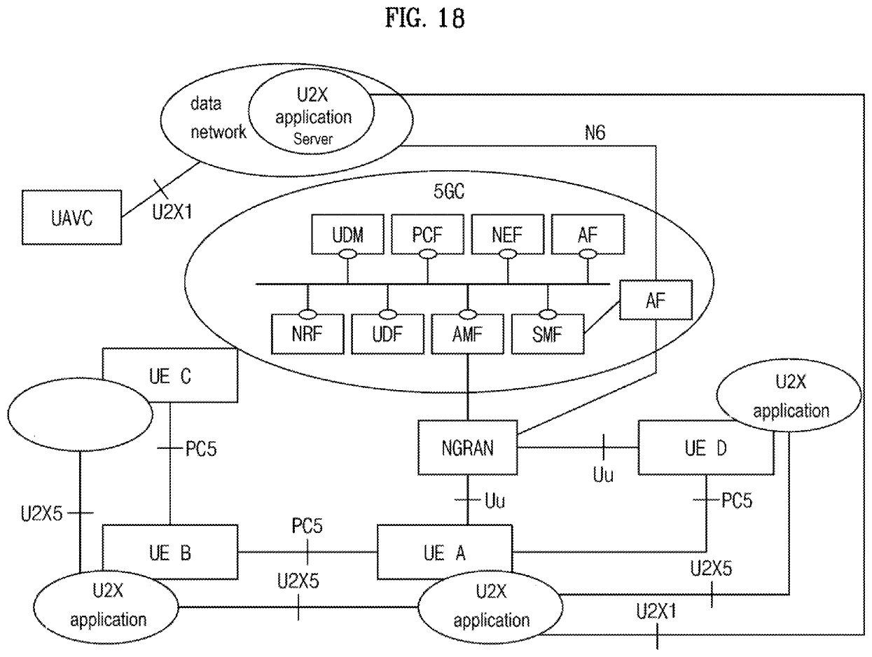

FIGS. 18 to 22 are diagrams illustrating a U2X system.

The key points of a proposed U2X solution in a specific scenario (TR 23.700-58) are as follows.
U2X may support BRID and direct DAA by using the V2X mechanism defined in TS 23.287. In this case, both LTE PC5 and NR PC5 as defined in TS 23.285 are supported, and RAT selection may be performed based on a U2XP.
Communication Mode: For broadcasting UAV identification (BRID), a broadcast communication mode may be used. In DAA, the broadcast communication mode may be used to advertise UAV information. Broadcast via PC5 or unicast via PC5 may be used between two or more UAVs for DAA deconfliction. Unicast via Uu through a U2X AS may not be supported in the above-described U2X solution. A groupcast mode for NR-based PC5 may not be supported in the above-described U2X solution. If NR PC5 is selected, connectionless groupcast communication may be used for DAA. Meanwhile, application layer managed groupcast may not be considered in the current release due to the lack of clear requirements.
U2X may be supported at a U2X application server, which interfaces with an operator network via an NEF, similar to a V2X application server.

For the specific scenario/solution, a dedicated set of services may be defined, and when a U2X AS providing a UAV and a USS are the same or different entities, multiple deployment scenarios need to be allowed.
A U2X policy (U2XP) may be defined to provide configuration parameters to a UE for U2X communication via a PC5 reference point or a Uu reference point. These configuration parameters may be preconfigured in a mobile equipment (ME), configured in a universal IC card (UICC), preconfigured in the ME and configured in the UICC, provided/updated by a U2X application server via a policy control function (PCF) and/or a V1 reference point, or provided/updated by the PCF to the UE. The UE needs to consider the U2XP in the order of priority: provided/updated by the PCF, provided/updated by the U2X application server via the V1 reference point, configured in the UICC, and preconfigured in the ME. A deconflicting policy may be a policy indicating a communication mode (unicast or broadcast) and a communication frequency for deconfliction.
Similar to V2X, a Tx profile or an NR Tx profile may be determined based on U2XP mapping of a U2X service type.
Both a UAV with a UICC and a UAV without a UICC (i.e., not subscribed to an MNO) may be supported. A UAV without a UICC may perform U2X communication only if authorized as “not provided in E-UTRA” and “not provided in NR”.
U2X communication parameters from the U2X application server or the PCF may be transmitted via a UAV-C UE.
In addition to the existing parameters for V2X, a geographic area, an altitude restriction, and a validity period timer may be set as radio parameters specific to a PC5 RAT (e.g., LTE PC5 and NR PC5). Such additional information/parameters may be needed to politically control PC5 usage according to a specific location of a UAV.
The definition of a DAA/UAV service type may go beyond the scope of the above-described specific scenario.
To use PC5-based communication for BRID and DAA in a UAV with a UICC, successful UUAA authentication/authorization as defined in TS 23.256 and authorization via U2XP should occur. However, the Federal Aviation Administration (FAA) does not require specific authorization for PC5 use for BRID or DAA. For a UAV without a UICC, the use of PC5-based communication for BRID and DAA may be authorized only by a U2XP. A U2X service may be identified by one of an ITS application identifier (ITS-AID), a provider service identifier (PSID), and an application identifier (AID) according to a value specifically defined for aviation applications.
Similar to TS 23.287, security for broadcast U2X communication via a PC5 reference point may be supported by a U2X application layer scheme developed in other SDOs.

Referring to FIG. 18, a non-roaming 5G system architecture for U2X communication via PC5 may be configured as illustrated in FIG. 18. The reference points of TS 23.287 may be applied to the non-roaming 5G system architecture for U2X communication via PC5, with the following differences.
U2X1: The reference point between the U2X applications in the UE, the UAV-C, and the U2X application server. This reference point is out of the scope of the specific scenario.
U2X5: The reference point between the U2X applications in the UE. This reference point is not specified in this release of the specific scenario.
N1: In addition to the relevant functions defined in TS 23.501 for N1, in the case of the U2X service, it is also used to convey the U2X policy and parameters (including service authorization) from the AMF to the UE and to convey the U2X capability and PC5 capability of the UE for U2X information from the UE to the AMF.
N2: In addition to the relevant functions defined in TS 23.501 for N2, in the case of the U2X Service it is also used to convey the U2X policy and parameters (including service authorization) from the AMF to the NG-RAN.
The above solution may support a UAV UE that utilizes Uu connectivity and a UAV UE that does not utilize Uu connectivity (i.e. either a UAV UE that is Uu capable or a UAV UE that does not use Uu). A UAV without utilizing Uu capabilities may use U2X for BRID and DAA and be configured via U2X1 over a transport outside the scope of the 3GPP. UAV UEs without utilizing Uu capabilities are part of the 3GPP ecosystem since they use U2X1 for configuration by a U2X application server and implement PC5 connectivity specified by the 3GPP.

A roaming 5G system architecture for U2X communication via PC5 may be configured as illustrated in FIGS. 19 and 20. Specifically, FIG. 19 illustrates a roaming 5G system architecture for U2X communication via PC5 in a local breakout scenario, and FIG. 20 illustrates a roaming 5G system architecture for U2X communication via PC5 in a home routing scenario.

An inter-public land mobile network (PLMN) 5G system architecture for U2X communication over a PC5 reference point may be as follows.
For inter-PLMN U2X communication via the PC5 reference point, PC5 parameters need to be set in a consistent manner among UEs within a specific area.
The architecture for inter-PLMN PC5 may be similar to the defined non-roaming 5G system architecture for U2X communication via PC5 described with reference to FIG. 18.

AF-based service parameter provisioning for U2X communication may be defined as follows.
As defined in TS 23.287, the 5G system may provide NEF services to enable communication between an NF in a PLMN and a U2X application server. FIG. 21 may illustrate a high level view of AF-based service parameter provisioning for U2X communication. Service parameters may also be preconfigured in UAVs (e.g. which do not utilize Uu capabilities) using methods that are out of the 3GPP scope.

The following may be considered in the U2X scenario.
Use/usage of U2X for BRID: The contents of a message for BRID are defined according to the regional regulations for BRID (e.g. message set of ASTM F3411.19 or ASD-STAN prEN 4709-002 P1) and optionally according to the regional mean of compliance documents.
Use/usage of U2X for DAA: The contents of a message for DAA are defined according to the regional regulations for DAA and may be out of the scope of the above-described specific scenario.

The procedures and mechanisms in TS 23.287 may be applied to the U2X scenario. Specifically, a procedure for broadcast via PC5 for DAA deconfliction may be performed as illustrated in FIG. 22. The procedure for broadcast via PC5 for DAA deconfliction may be based on the pre-requisite that a UAV is provisioned with a U2X policy which includes a DAA deconflicting policy (e.g., unicast or broadcast communication for deconflicting, and a communication frequency).

Specifically, the procedure for broadcast via PC5 for DAA deconfliction in FIG. 22 may be performed as follows.

1. UAV1 may receive, from UAV2, a broadcast message that may include application layer DAA payload (e.g., a CAA-level UAV ID, and the address, velocity, heading direction, and location of UAV2).
NOTE 1: The unmanned aerial system traffic management (UTM) service supplier (USS) address is not needed if conflict is resolved locally between UAVs, but may be helpful if it requires the coordination of the USSes of the UAVs involved in the conflict.

2. UAV1 may transmit the DAA payload to the upper layer. The application layer may detect a conflict, based on the broadcast message received from UAV2, for example, by comparing it with its own trajectory and location. If the application layer in UAV1 detects a collision, it initiates a collision avoidance/conflict resolution procedure with UAV2.

3. Optionally, UAV1 may inform its own USS of the detected collision by including the ID of the peer UAV2.

4. UAV1 may select a communication mode (broadcast or unicast) for DAA

deconfliction based on an input received from the application layer and the DAA policy. When a broadcast deconfliction method is selected, the following messages may be exchanged between the UAVs.

5. UAV1 may broadcast a message (e.g., PC5-S message), (e.g. a deconfliction request message), which may include a DAA capability, which is part of a U2X capability and indicates whether the UAV is able to engage in communication for a deconflicting protocol, a DAA deconflicting policy (broadcast based, and a deconflicting message frequency), collision detection alert, its CAA-level UAV IDs and the one(s) from other detected conflicting UAV(s), and specific parameters (e.g., trajectory correction information to avoid a collision).

6. UAV2 may broadcast a message (e.g., PC5-S message) to provide an agreed DAA deconflicting policy, an updated trajectory, and other information (e.g. message deconfliction status response, conflict resolved alert, and CAA-level UAV IDs of participating UAVs from the receiving UAV). Subsequent broadcast messages may be exchanged between the UAVs until traffic conflict resolution is reached (e.g., for mutual location/trajectory monitoring) based on an agreed message frequency.

Impacts on the above-described services, entities, and interfaces related to U2X may be as described in Table 8 and Table 9.

TABLE 8

| | |
|---|---|
| 1. | UE: In addition to the functions defined in TS 23.501, the UE may |

support the following functions:

Report the U2X Capability (including DAA Capability) and PC5

Capability for U2X to 5GC over N1 reference point.

Indicate U2X Policy Provisioning Request in UE Policy Container for UE

triggered U2X Policy provisioning.

Receive the U2X parameters from 5GC over N1 reference point.
Procedures for U2X communication over PC5 reference point.
Configuration of parameters for U2X communication. These parameters

can be pre-configured in the UE, or, if in coverage, provisioned or updated by
signalling over the N1 reference point from the PCF in the HPLMN or over
U2X1 reference point from the U2X Application Server.

| | |
|---|---|
| 2. | AMF: In addition to the functions defined in TS 23.501, the AMF |

performs the following functions:

Obtain from UDM the subscription information related to U2X and store

them as part of the UE context data.

Select a PCF supporting U2X Policy/Parameter provisioning and report

the PC5 Capability for U2X to the selected PCF.

Obtain from PCF the PC5 QoS information related to U2X and store it as

part of the UE context data.

Provision the NG-RAN with indication about the UE authorization status

about U2X communication over PC5 reference point.

Provision the NG-RAN with PC5 QoS parameters related to U2X

communication.

PCF: In addition to the functions defined in TS 23.501, the PCF includes

the functions described in 23.287 to provision the UE and AMF with necessary
parameters in order to use U2X communication.

UDM: Subscription management for U2X communication over PC5

reference point. The UE subscription data types are extended according to the
following table 6.

| | |
|---|---|
| 3. | U2X Application Server: implements a subset of the V2X AS |

functionality specified in TS 23.287:

includes AF functionality, and may support at least the following

capabilities:

For U2X service parameters provisioning, the U2X AS provides the 5GC

and the UAV UE (possibly via the UAVC) with parameters for U2X
communications over PC5 and Uu reference points.

UDR: In addition to the functions defined in TS 23.501, the UDR stores

U2X service parameters.

NRF: In addition to the functions defined in TS 23.501, the NRF

performs PCF discovery by considering U2X capability.

NEF: for U2X AS, the NEF supports U2X service parameters.

TABLE 9

| | | |
|---|---|---|
| U2X | NR U2X | Indicates whether the UE is authorized to use |
| Subscription | Services | the NR sidelink for U2X services as UAV |
| data | Authorization | UE, UAV-C UE, or Authority UE. |
| | LTE U2X | Indicates whether the UE is authorized to use |
| | Services | the LTE sidelink for U2X services as UAV |
| | Authorization | UE, UAV-C UE, or Authority UE. |
| | NR UE-PC5- | AMBR of UE's NR sidelink (i.e. PC5) |
| | AMBR | communication for U2X services. |
| | LTE UE-PC5- | AMBR of UE's LTE sidelink (i.e. PC5) |
| | AMBR | communication for U2X services. |

Further, the recent discussion related to the above specific scenario is illustrated in Table 10.

TABLE 10
Measurement Reporting

```
  Use LTE principle as a baseline, introduce similar event H1 (aerial UE height
become higher than threshold) and H2 (aerial UE height become lower than
threshold. FFS if further NR enhancements are needed. FFS study scaling of
RRM parameters (e.g. which parameters and what is the purpose/benefit of the
scaling and how)
    FFS how to limit excessive measurements and measurement reporting.
    FFS if user consent is needed for location reporting in CONNECTED
    FFS study the vertical movement and associated mobility for UAV UEs
  Rel-18 NR supports reporting of UAV UE's height, location and velocity. It is
for further study what accuracy and reporting mechanisms are required and if
further enhancements are needed.
  As in LTE, flight path plan reporting will be introduced. Location list of
waypoints (3D location information) and timestamp is adopted as the basic content
of flight path report. FFS if timestamp is mandatory or optional for NR. FFS if
further enhancements are needed.
  Introduce similar functionality to LTE (numberofTriggeringCells). FFS whether
numberoftriggerbeams for NR is required or other enhancements. FFS study how
to avoid sending the measurement reports mainly due to reportOnLeave.
  A waypoint is a planned location for the UE along the flight path and is described
via the existing parameter type LocationCoordinates defined in TS 37.355.
  A timestamp provides the UTC time associated with estimated time of arrival to a
waypoint as baseline. FFS on granularity.
  No requirements are placed on spatial distribution of waypoints.
  A UE indicates whether flight plan information is available within the
RRCReconfigurationComplete, RRCReestablishmentComplete,
RRCResumeComplete, or RRCSetupComplete message. Flight path reporting
uses at the UE Information request/response procedure as baseline.
  UE indicates to the network a new flight path is available in the UE (whether it is
initial or update). Then, reuse the normal request/response procedure of flight path
report.
  UAI message can also be used to indicate the UE has flight path availability.
  FFS whether and what triggering conditions are specified for flight update. FFS
The maximum number of waypoints within flight path plan is left FFS.
  When event H1 or H2 triggers, the content of the measurement report is
configurable by the network (i.e. it can contain UAV UEs height, location
information and/or RSRP/RSRQ measurement results). FFS whether UAV UE's
height is mandatorily reported and which parameter/IE is used for height reporting
  Joint use of height-dependent condition and RSRP/RSRQ/SINR-based condition
for measurement report triggering is supported in NR Rel-18 UAV. The
combination of existing events will be used.
  Height-dependent parameter scaling is not supported as a part of Rel-18 NR
  Do not extend the Number of triggering cells mechanism to apply to the inter-
RAT scenario, i.e. event B1 and B2 triggering.
  Do not restrict the applicability of Number of triggering cells mechanism to FR1
only. In other words, the Number of triggering cells mechanism is applicable to
FR1 and FR2 (up to network configuration).
  The UE shall not ignore or bypass the Number of triggering cells mechanism,
once configured.
  Do not introduce the use of a “numberOfTriggeringBeams” mechanism.
  Do not introduce an alternative mechanism to the Number of triggering cells
mechanism.
  Do not introduce an additional mechanism based on Number of changed cells.
  For the purpose of interference control (i.e. for number of trigger cells), do not
introduce a prohibit timer mechanism.
  Report on leave is not triggered by a cell that was not previously included in the
measurement report for the number of triggering cell.
  Support configuring height-dependent more-than-one configurations targeting
measurement and measurement reporting enhancement. UE applies corresponding
configuration based on the UE height. The proposed solutions should aim at
avoiding RAN4 impacts. FFS how this would be configured (i.e. different MO
configurations or different parameters FFS Exact parameters and details.
  Height-dependent more-than-one configurations is supported on parameter/field
level (i.e. different fields/values within the same MO) where different values (or
value ranges) of the parameter/field applies to different height or height range.
  For MO configuration parameters: at least the following will have ability to be
configured with height-dependent more-than-one configurations/values, each for a
specific height region: SSB-ToMeasure. Details on how to specify is FFS. FFS
on UE behavior on L1 and L3 measurement.
  For MR configuration parameters: at least the following will have ability to be
configured with height-dependent more-than-one configurations/values, each for a
specific height region: Event A4 threshold and numberoftriggeringcells. Details
on how to specify is FFS (i.e. maybe it can be achieved by combination of events).
  When height-dependent more-than-one configurations are provided, UE applies
the new value once it moves to new height (or height range) similar to the case of
RRC reconfiguration. Need Codes, field descriptions, etc. as in legacy
specifications apply.
  If a height-specific value is not explicitly configured for certain height, whether
to keep using the value that was used or consider the parameter as released (i.e.
parameter/value not applicable at this height) should be looked into case by case,
and can be clarified by need code, field description, or procedural text as needed.
FFS details.
```

A handover (HO) procedure considering the above-described UAV UE characteristics will be described below in detail.

### Handover Procedure for UAV UE

### 1. Method 1

Characteristically, a UAV UE may be subject to severe fluctuation (up/down/left/right) at a high speed. Therefore, a measurement performed by the UAV UE may have a dependency on a height/region. For example, when a gNB configures a measurement for the UAV UE, the UAV UE may be configured to report separate measurement values based on its height/geographical regions/ranges. That is, a highly fluctuating UAV UE may report a measurement result (e.g., using an L3 filter) for a neighbor cell in height (or geographical region) range 1 and a measurement result for the neighbor cell in height (or geographical region) range 2, separately (e.g., along with height range information). For example, when reporting its measured values, the UAV UE may report height (or geographical region) range IDs together. The used height (or geographical region) ranges or height range ID information may be configured together during the measurement configuration, and a threshold that triggers the report may also be set to a different value depending on a height/geographical region or height range.

When the gNB receives the measurement values from the UAV UE, which are dependent on the heights (or geographical regions)/height ranges, the gNB may determine HO based on the measurement values, and may also configure the HO such that a different target cell is selected depending on a height (or geographical region)/height range. For example, the gNB may configure a multiple HO configuration through a single RRC message, instructing the UAV UE to perform HO to cell A if it is located/positioned in height (or geographical region)/height range 1, and HO to cell B if it is located/positioned in height (or geographical region)/height range 2. In other words, the gNB may transmit a multiple HO configuration to the UAV UE through a single RRC message, configuring a plurality of target cells for HO for each of a plurality of height ranges.

When the UAV UE that has received such an HO command/configuration completes HO to any one cell, the target cell/gNB that has completed the HO may notify a source cell/gNB of information related to the HO. In this case, the source cell/gNB may transmit a message for canceling HO to other candidate cells/gNBs (to which the UAV UE has not completed HO) that were configured for the UAV UE. In other words, the UAV UE may perform HO to one target cell corresponding to its height range among the target cells included in the multiple HO configuration, the one target cell may provide information related to HO completion to the source cell/gNB, upon completion of the HO with the UAV UE, and upon receipt of the information related to the HO completion, the source cell/gNB may transmit a message for cancelling HO to the remaining target cells.

### 2. Method 2

When the gNB configures a measurement for the UAV UE, it may also set a height/geographical region range and a hysteresis value in which the measurement is to be performed. For example, the gNB may configure the UAV UE to perform a measurement within a height range of +/−10m from a current position. Alternatively, when the height range is preconfigured, the gNB may set the hysteresis value for the preconfigured height range for the UAV UE. The UAV UE that has been configured with this may perform the measurement within the set height range. For example, when the movement fluctuation of the UAV UE occurs only within the set height (+/−hysteresis) range, the UAV UE may keep a measured value. In contrast, when the UAV UE moves outside the set height (+/−hysteresis) range, the UAV UE may initialize the measured value and restart a measurement at a new position. When the resulting measurement value is reported, the HO procedure may follow the existing HO procedure (refer to TS 38.331) or the method proposed in ‘Method 1’ described above.

### 3. Method 3

Two (or more) thresholds for a measurement report (or thresholds that trigger a measurement report) may be set. The set thresholds may be values that have a dependency on a height/geographical region (range). For example, threshold 1 may be set for height/geographical region (range) A where the UAV UE is currently located/positioned, and threshold 2 may be set for height/geographical region (range) B which is adjacent/neighboring to height/geographical region (range) A. In this case, it may be assumed that the UAV UE is in an environment where although it reports its current height/geographical region (range) as height/geographical region (range) A, it may also perform a measurement in height/geographical region (range) B due to (position) fluctuation.

When a Uu measurement result value measured in height/geographical region A is determined to be less than (/less than or equal to) threshold 1, triggering a measurement report, and a Uu measurement result value measured in the other height/geographical region B is equal to or greater than (/greater than) threshold 2, not triggering a measurement report, the UAV UE may report only the measurement value measured in height/geographical region A (to the gNB).

On the contrary, when the Uu measurement result value measured in height/geographical region A is greater than or equal to (/greater than) threshold 1, not triggering a measurement report, but the Uu measurement result value measured in the other height/geographical region B is less than (/less than or equal to) threshold 2, triggering a measurement report, the UAV UE may report only the measurement value measured in height/geographical region B (to the gNB).

Alternatively, when the Uu measurement result value measured in height/geographical region A is determined to be less than (/less than or equal to) threshold 1, triggering a measurement report, and the Uu measurement result value measured in the other height/geographical region B is less than (/less than or equal to) threshold 2, triggering a measurement report, the UAV UE may report the measurement value in height/geographical region A and the measurement value in height/geographical region B, separately.

Alternatively, the UAV UE may also report information about a height/geographical region (height/geographical region A or B) where it is currently located/positioned, along with the measurement value.

The term height/geographical region (range) mentioned above may be used interchangeably with the term specific area (range).

In the proposed method described above, a UAV with severe position fluctuation separately reports a measurement value for HO on a height basis, and triggers a measurement report on a height basis. Accordingly, HO suitable for a UAV environment may be expected.

### Measurement Report Triggering Condition for Low-Power UAV Remote UE

Hereinafter, a relay UE for a UAV remote UE may be a UAV (relay) UE. Since the UAV remote UE is located at a high altitude, it may be advantageous for a low-power operation that it is connected to the UAV relay UE. For example, when the connection status between the UAV relay UE and the UAV remote UE is considered reliable enough, it may be advantageous for a low-power operation that the UAV remote UE is connected to the UAV relay UE. The connection between the UAV remote UE and the UAV relay UE may refer to an SL and/or non-3GPP (e.g., Wi-Fi or Bluetooth) connection. To enable a multi-path connected UAV remote UE to release its direct link for a low-power operation, a related condition for triggering a measurement report will be described below in detail.

Further, a UAV relay may be replaced by a vehicle on the ground, and a UAV remote UE may be replaced by a mobile device of a vehicle occupant in the following description. Alternatively, a UAV relay UE may be replaced by a mobile device, and a UAV remote UE may be replaced by another low-power UE such as a smartwatch connected to a mobile device.

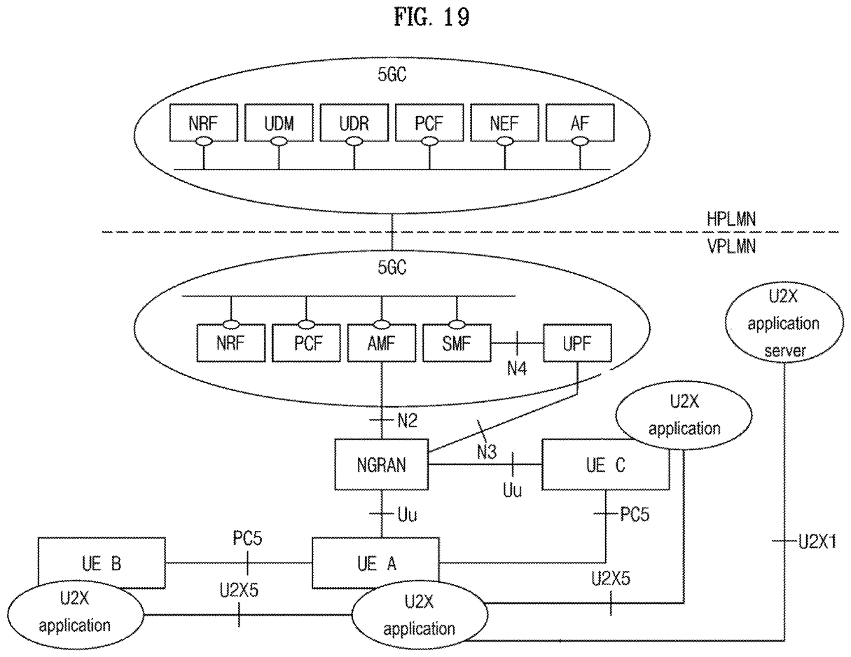

FIG. 23 is a diagram illustrating connections among a UAV remote UE, a UAV relay UE, and a gNB.

Referring to FIG. 23, a UAV itself may be a relay UE (e.g., a UAV relay UE), and a mobile device of a passenger onboard the UAV may be a remote UE (e.g., a UAV remote UE). Although the UAV remote UE may have both a direct path and an indirect path (as described above, the indirect path is a path where the UAV remote UE is connected to the gNB through the UAV relay UE), it may be advantageous to establish only the indirect path, for a low-power operation.

Specifically, a measurement report (for release of the direct path) of the UAV remote UE may be triggered in the following cases.
When a signal strength between the UAV remote UE and the UAV relay UE (i.e., a signal strength of the indirect path/indirect link) is greater than threshold 1 (set via an SIB, RRC dedicated, or preconfigured).
Alternatively, when the signal strength between the UAV remote UE and the UAV relay UE (i.e., the signal strength of the indirect path/indirect link established between the remote UE and the serving relay UE) is greater than threshold 1, and a signal strength of a Uu link between the UAV remote UE and the BS (i.e., gNB) is less than threshold 2.

When a measurement report (for release of the direct path) is triggered based on the above condition, the UAV remote UE may perform measurement reporting (for the direct path) to the BS via the direct path and/or the indirect path, and upon receipt of the measurement report, the BS may determine whether to release the direct path (or Uu link) with the remote UE. When the BS determines to release the direct path, it may transmit configuration information for releasing the direct path to the remote UE.

Alternatively, the above-described measurement triggering condition (or the condition for triggering a measurement report for release of the direct path) may be configured differently depending on a height. For example, the UAV environment is highly likely to be a LOS environment, and the path loss may also increase as the height increases. In this case, when the UAV remote UE (located at or above a specific height) transmits a UL signal, it may not be appropriate in terms of power saving for the UAV remote UE. Therefore, threshold 1 and/or threshold 2 (or the difference between threshold 1 and threshold 2) needs to be set differently depending on a height.

The above-described UAV (channel) environment may have a much greater interference effect than in the case of a UE on the ground due to LoS. In this case, the higher the remote UE goes, the more transmission power may be required for transmission of a UL signal. Therefore, for power saving of the remote UE, an operation of releasing the direct path sooner may be necessary as the height increases. To this end, threshold 1 and/or threshold 2 needs to be set differently depending on a height.

Alternatively, a method may be defined to indicate whether a measurement report triggered by the UAV remote UE is for simply changing the existing direct path to a new direct path because the quality of the direct path (the path between the UAV remote UE and the gNB) has deteriorated, or for releasing the direct path for power saving. For example, the UAV remote UE may distinguish between the two measurement reports described above by also reporting information about an event that triggers the measurement report in the measurement report.

Alternatively, the above threshold (threshold 1 and/or threshold 2) may be adjusted/changed by an offset, a hysteresis value, or the like, and the offset and the hysteresis value may also be values that are set/applied differently depending on the height of the UAV remote/relay UE.

Alternatively, the above threshold (threshold 1 and/or threshold 2) for measurement reporting may be a value that is set differently for the x, y, and z axes in three dimensions. Alternatively, the threshold (threshold 1 and/or threshold 2) for measurement reporting may be a value that is set differently depending on the movement speed of the UAV remote/relay UE.

Alternatively, the UAV remote UE and the UAV relay UE may be connected to each other via a non-3GPP link, instead of an SL interface. In this case, it may become ambiguous when a measurement report is triggered at the UAV remote UE. This is because it may not be appropriate for the BS for 3GPP communication to set a threshold related to a signal strength between UEs performing a non-3GPP operation. Therefore, when the UAV remote UE and the UAV relay UE are connected via a non-3GPP link, determining whether the signal strength between the UAV remote UE and the UAV relay UE is sufficiently stable may be an implementation issue for the UAV remote UE.

For example, when the non-3GPP link connection between the UAV remote UE and the UAV relay UE is determined to be sufficiently stable, the above-described measurement report may be triggered at the UAV remote UE. Alternatively, when the non-3GPP link connection between the UAV remote UE and the UAV relay UE is determined to be sufficiently stable, and the signal strength of the Uu link between the UAV remote UE and the BS is less than threshold 2, the measurement reporting may be triggered at the UAV remote UE.

The UAV remote UE may transmit a message requesting the release of the direct link to the gNB/BS via the direct path and/or the indirect path. Alternatively, when a measurement report is triggered, the UAV remote UE may report measurement information to the gNB/BS, which further includes information indicating that the signal strength between the remote UE and the relay UE is ideal (or a predefined indication to indicate that the non-3GPP link connection is sufficiently stable).

Alternatively, even when the UAV remote UE and the UAV relay UE are connected via a non-3GPP link, the distinction method may be defined to indicate whether the measurement report triggered by the UAV remote UE is for simply changing the existing direct path to a new direct path because the quality of the direct path (the path between the UAV remote UE and the gNB) has deteriorated, or for releasing the direct path, for power saving, as described above. For example, the UAV remote UE may distinguish between the two measurement reports described above by also reporting information about an event that triggers the measurement report in the measurement report.

Alternatively, even when the UAV remote UE and the UAV relay UE are connected via a non-3GPP link, the above threshold (or threshold 2) may be adjusted/changed by an offset, a hysteresis value, or the like, and the offset and hysteresis value may also be values that are set/applied differently depending on the height of the UAV remote/relay UE, as described above.

Alternatively, even when the UAV remote UE and the UAV relay UE are connected via a non-3GPP link, the threshold (or threshold 2) for measurement reporting may be a value that is set differently for the x, y, and z axes in three dimensions, as described above. Alternatively, the threshold (threshold 1 and/or threshold 2) for measurement reporting may be a value that is set differently depending on the movement speed of the UAV remote/relay UE.

The direct path of the UAV remote UE (or remote UE) established as a multi-path may be deactivated or released by the gNB in a specific scenario (3GPP Rel-19). For example, the direct path may be released by the gNB based on the height of the UAV remote UE onboard the UAV. Alternatively, multi-path relay based on a non-3GPP U2U (UE-to-UE) link in a specific scenario (3GPP Rel-18) may be enhanced for UAM.

As such, the proposed method described above may clearly indicate to the gNB whether the measurement report is for releasing the direct path for the UE operating as a UAV remote UE, effectively ease the condition for releasing the direct path in response to a height increase by setting a height-based threshold, and ensure maximum power saving for the UAV UE through the easing of the condition for releasing the direct path.

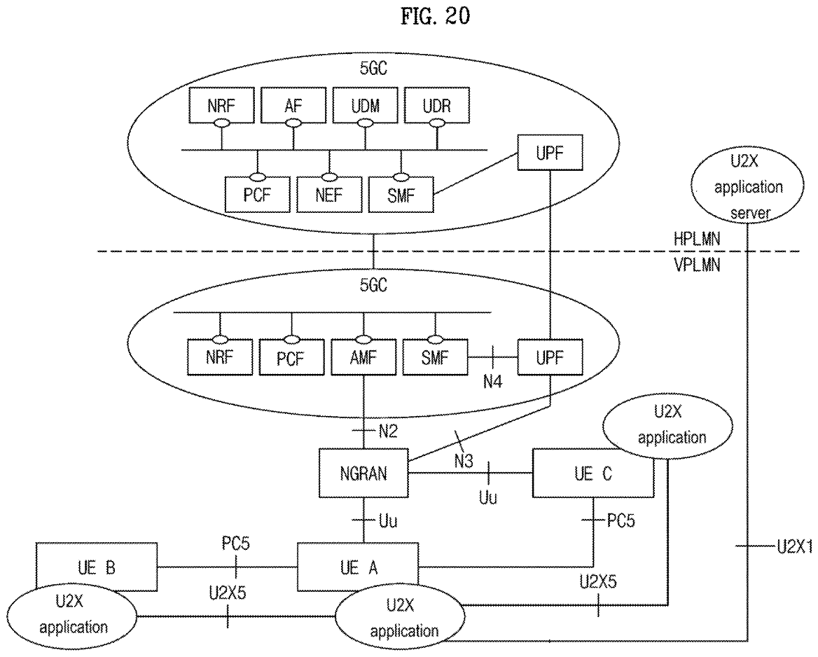

FIG. 24 is a diagram illustrating a method for triggering a measurement report by a first UE.

The first UE may be a UE for which multiple paths have been established, including a direct path connected directly to a BS and an indirect path connected to the BS via a second UE. The first UE may be a UAV remote UE, and the second UE may be a UAV relay UE, as described above. In this case, the first UE may be located at various heights/altitudes, and the communication status with the BS may vary depending on the height.

Referring to FIG. 24, the first UE may receive configuration information configuring a first threshold for the direct path and a second threshold for the indirect path (S241). The first threshold and the second threshold may be set to different values depending on the height/height range of the first UE.

For example, the configuration information may differently set at least one of the first threshold or the second threshold based on the height of the first UE. For example, the configuration information may set a (1-1)^{th} threshold when the height of the first UE is a first height, and a (1-2)^{th} threshold different from the (1-1)^{th} threshold when the height of the first UE is a second height greater than the first height. The (1-2)^{th} threshold may be greater than the (1-1)^{th} threshold. That is, the configuration information may set a greater first threshold as the height of the first UE increases. Alternatively, the configuration information may set a (2-1)^{th} threshold when the height of the first UE is a first height and a (2-2)^{th} threshold different from the (2-1)^{th} threshold when the height of the first UE is a second height greater than the first height. The (2-2)^{th} threshold may be less than the (2-1)^{th} threshold. That is, the configuration information may set a smaller second threshold as the height of the first UE increases.

Alternatively, the configuration information may include a plurality of first thresholds and/or a plurality of second thresholds for a plurality of heights/height ranges. In this case, the first UE may select/set a first threshold and/or a second threshold corresponding to its height from among the plurality of first thresholds and/or the plurality of second thresholds.

Subsequently, the first UE may trigger a measurement report related to release of the direct path based on the first threshold and the second threshold (S243). Specifically, as described in the section “Measurement Report Triggering Condition for Low-Power UAV remote UE,” the first UE may trigger the measurement report for releasing the direct path (i.e., only the release of the direct path is performed without changing/handover of the direct path). This is because when the first UE is located at a high altitude/height, transmitting a signal via the indirect path through the second UE is much more advantageous in terms of transmission power consumption than transmitting a signal via the direct path (Uu link). In this case, the first UE may prevent/minimize power consumption caused by the transmission power of the signal via the direct path, which increases significantly with the height of the UE, by releasing the direct path and only transmitting/receiving signals via the indirect path.

For example, the first UE may determine whether to trigger a measurement report for releasing the direct path based on the first threshold and/or the second threshold which is set to correspond to its height according to the configuration information. When the signal strength of the direct path is less than the first threshold set to correspond to its height, and the signal strength of the indirect path is greater than the second threshold, the first UE may trigger the measurement report related to release of the direct path. Conversely, when the signal strength of the direct path is less than the first threshold set to correspond to its height, and the signal strength of the indirect path is less than the second threshold, the first UE may trigger a measurement report for changing the direct path (i.e., handover), not for releasing the direct path.

Subsequently, the first UE may report a measurement report/measurement information related to release of the direct path (S245). The first UE may transmit/report measurement information/a measurement report to the BS, which includes a first signal strength (less than the first threshold) measured for the direct path and/or a second signal strength measured for the indirect path. The signal strengths may be received signal strength indicators (RSSIs), reference signal received powers (RSRPs), or signal to interference plus noise ratios (SINRs). As described above, the triggered measurement report may be for changing the direct path or for releasing the direct path. Therefore, to enable the BS to distinguish between the measurement report for changing the direct path and the measurement report for releasing the direct path, the first UE may report the measurement report/or measurement information to the BS via the indirect path, which further includes indication information or event information (an additionally defined event) indicating that it is for releasing the direct link without changing the direct link.

Thereafter, the first UE may receive a message (e.g., RRC Reconfiguration message) including configuration information for releasing the direct path from the BS, and release the direct path based on the message. In this case, the first UE may transmit/receive a signal to/from the BS via the indirect path.

Alternatively, the configuration information may further set at least one height range related to the measurement report. In this case, the first UE may perform a measurement for the measurement report for each of the at least one height range. For example, when the at least one height range includes a first height range and a second height range, the first UE may perform a measurement in the first height range and a measurement in the second height range independently. The first UE may report a measurement report/measurement information to the BS, which further includes identification information about the height range where the measurement was performed among the at least one height range. For example, when the signal strength of the direct path is less than the first threshold set to correspond to the height of the first UE, and the signal strength of the indirect path is less than the second threshold, the first UE may trigger a measurement report for changing the direct path (i.e., handover), not for releasing the direct path. In this case, as described in “Handover Procedure for UAV UE,” the first UE may perform a measurement (measurement of a signal strength from a neighboring cell) in the height range corresponding to its height among the at least one height range, and report a measurement report/measurement information to the BS, which includes a measurement result (i.e., a measurement value) and the ID of the corresponding height range. The first UE may receive a message related to handover from the BS, which configures a different target cell for each height range, and select a target cell corresponding to its height to perform the handover procedure.

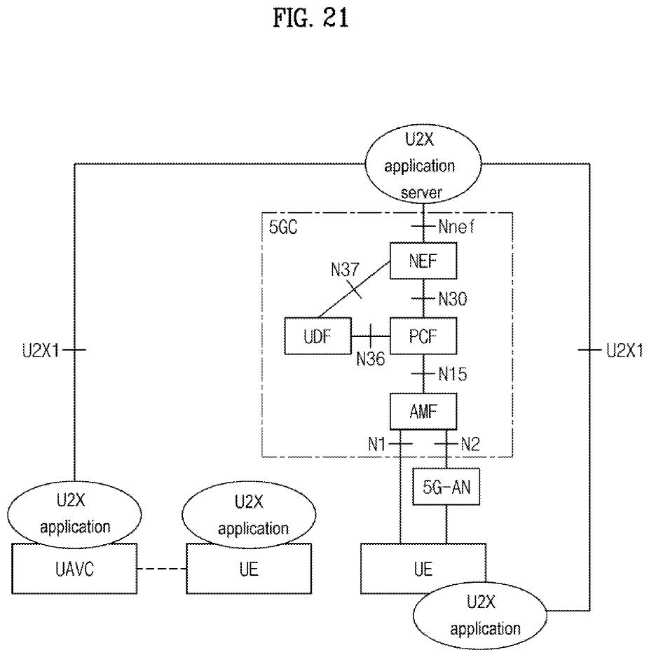

FIG. 25 is a diagram illustrating a method for receiving a measurement report from a first UE by a BS.

Referring to FIG. 25, the BS may transmit configuration information configuring a first threshold for a direct path connected directly to the first UE and a second threshold for an indirect path connected to the first UE via a second UE (S251). As described in FIG. 24 and “Measurement Report Triggering Condition for Low-Power UAV remote UE,” the configuration information may set a different first threshold and/or second threshold for each height range of the first UE. As described above, the first threshold and the second threshold may be thresholds for the condition that triggers a measurement report for releasing the direct path. Alternatively, the configuration information may include information about at least one height range related to the performance of a measurement for the measurement report.

Subsequently, the BS may receive a measurement report related to release of the direct path, triggered based on the first threshold and the second threshold (S253). As described above, the measurement report may be reported when the first UE measures a signal strength of the direct path to be less than/equal to or less than the first threshold, and a signal strength of the indirect path to be equal to or greater than/greater than the second threshold.

Subsequently, the BS may transmit a message including configuration information for releasing the direct path of the first UE to the first UE based on the measurement report (S255). In this case, the BS may perform a procedure for releasing the direct path with the first UE, and transmit/receive signals to/from the first UE via the indirect path.

As such, the proposed disclosure may effectively release a direct path based on a height increase by separately defining a condition for triggering a measurement report only for releasing a direct path. Alternatively, the proposed disclosure may release the direct path only when communication with a BS via an indirect path is sufficiently guaranteed by defining both a signal strength of the indirect path and a signal strength of the direct path as the condition for triggering a measurement report related to release of a direct path. Alternatively, the proposed disclosure may more quickly perform measurement reporting for the release of the direct path corresponding to a height increase by setting a different threshold for triggering a measurement report for releasing a direct path depending on the height of the UAV remote UE. Alternatively, the proposed disclosure may effectively ensure the low-power operation of a UAV remote UE by preventing/minimizing the increase in power consumption of the UAV remote UE caused by the increase in the transmission power of the direct path accompanying the height increase, by defining the measurement report for releasing a direct path.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

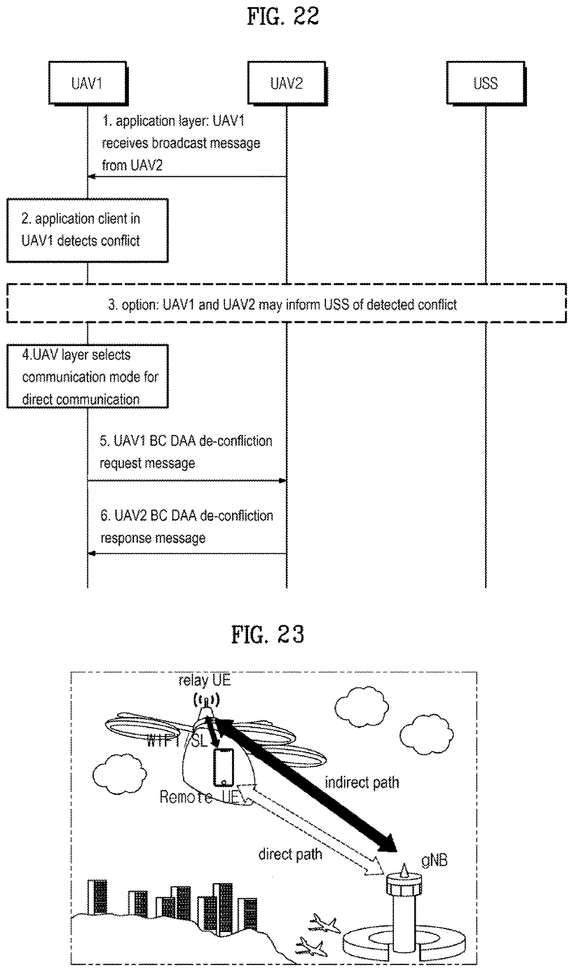

FIG. 26 illustrates a communication system applied to the present disclosure.

Referring to FIG. 26, a communication system 1 applied to the present disclosure includes wireless devices, BSs (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

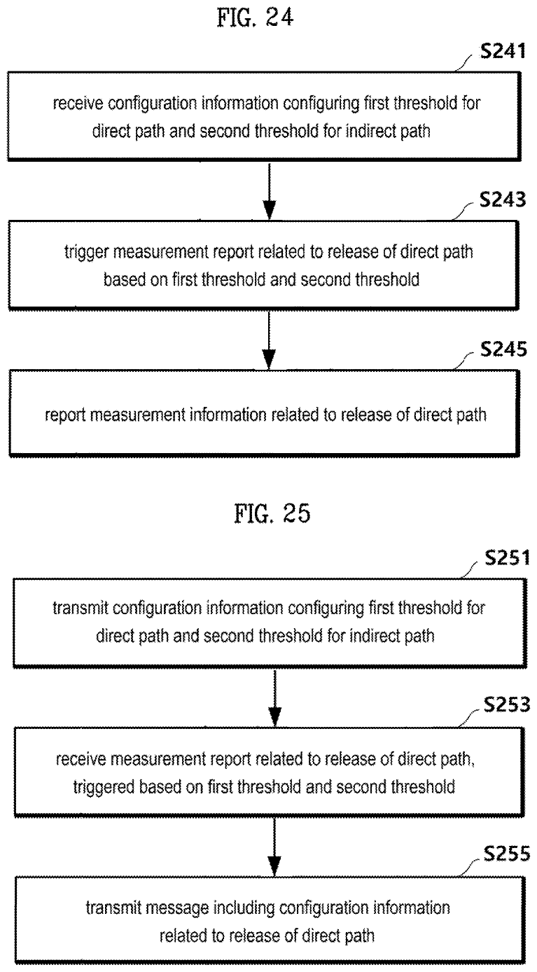

FIG. 27 illustrates a wireless device applicable to the present disclosure.

Referring to FIG. 27, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 26.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the first wireless device or first UE 100 may include the processor 102 connected to the transceiver 106, and the memory 104. The memory 104 may include at least one program for performing operations related to the embodiments described in FIGS. 24, 25, and 26, “Measurement Report Triggering Condition for Low-Power UAV remote UE,” and “Handover Procedure for UAV UE”.

The processor 102 may control the transceiver 106 to receive configuration information configuring a first threshold for a direct path directly connected to a BS and a second threshold for an indirect path connected to the BS via a second UE, and trigger the measurement report related to release of the direct path based on the first threshold and the second threshold. The configuration information may set at least one of the first threshold or the second threshold differently based on a height of the first UE.

Alternatively, a processing device for controlling a first UE triggering a measurement report, which includes the processor 102 and the memory 104, may be configured. In this case, the processing device may include at least one processor, and at least one memory connected to the at least one processor and storing instructions that, when executed by the at least one processor, cause the first UE to receive configuration information configuring a first threshold for a direct path directly connected to a BS and a second threshold for an indirect path connected to the BS via a second UE, and trigger the measurement report related to release of the direct path based on the first threshold and the second threshold. The configuration information may set at least one of the first threshold or the second threshold differently based on a height of the first UE.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Specifically, the second wireless device or BS 200 may include the processor 202 connected to the transceiver or RF transceiver 206, and the memory 204. The memory 204 may include at least one program for performing operations related to the embodiments described in FIGS. 24, 25, and 26, “Measurement Report Triggering Condition for Low-Power UAV remote UE,” and “Handover Procedure for UAV UE”.

The processor 202 may control the transceiver 206 to transmit configuration information configuring a first threshold for a direct path directly connected to the first UE and a second threshold for an indirect path connected to the first UE via a second UE, and receive the measurement report related to release of the direct path, triggered based on the first threshold and the second threshold. The configuration information may set at least one of the first threshold or the second threshold differently based on a height of the first UE.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Disclosure is Applied

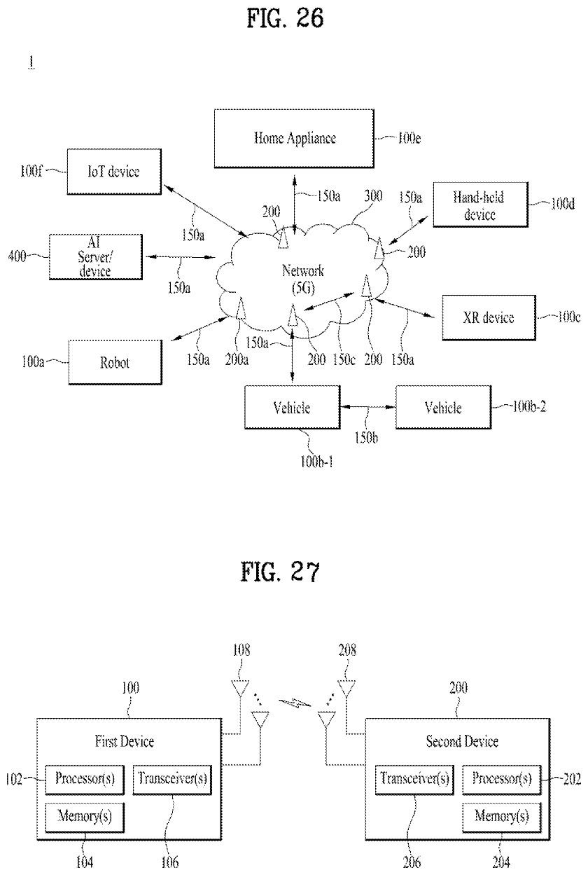

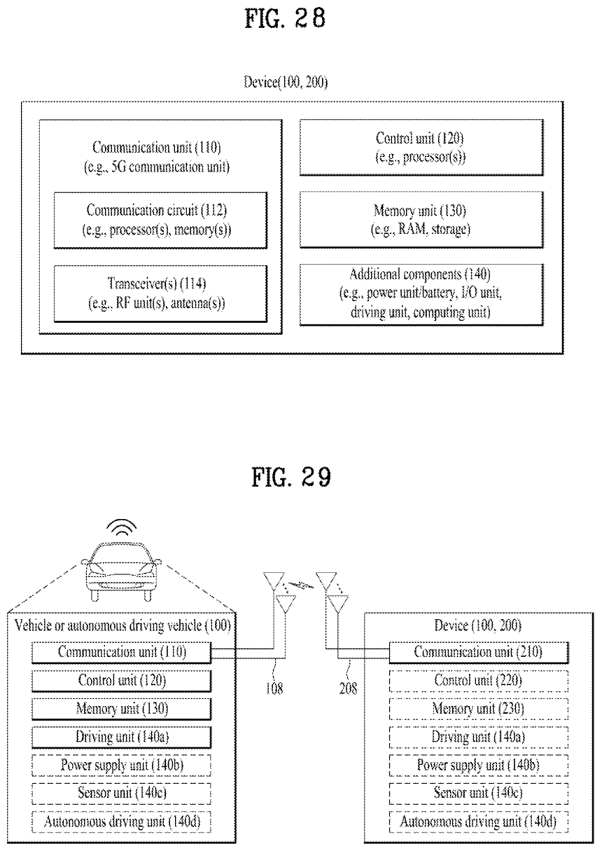

FIG. 28 illustrates another example of a wireless device applied to the present disclosure. The wireless device may be implemented in various forms according to a use-case/service (refer to FIG. 29).

Referring to FIG. 28, wireless devices 100 and 200 may correspond to the wireless devices 100 and 200 of FIG. 27 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 27. For example, the transceiver(s) 114 may include the one or more transceivers 106 and 206 and/or the one or more antennas 108 and 208 of FIG. 27. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 26), the vehicles (100b-1 and 100b-2 of FIG. 26), the XR device (100c of FIG. 26), the hand-held device (100d of FIG. 26), the home appliance (100e of FIG. 26), the IoT device (100f of FIG. 26), a digital broadcast terminal, a hologram device, a public safety device, an MTC device, a medicine device, a fintech device (or a finance device), a security device, a climate/environment device, the AI server/device (400 of FIG. 26), the BSs (200 of FIG. 26), a network node, etc. The wireless device may be used in a mobile or fixed place according to a use-example/service.

In FIG. 28, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of Vehicles or Autonomous Vehicles to which the Present Disclosure is Applied

FIG. 29 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 29, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 28, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are combinations of the components and features of the present disclosure in a predetermined form. Unless explicitly stated otherwise, each component or feature should be considered optional. Each component or feature may be implemented in a form not combined with other components or features. It is also possible to combine some components and/or features to constitute an embodiment of the present disclosure. The order of operations described in the embodiments of the present disclosure may be changed. Some configurations or features of one embodiment may be included in another embodiment, or may be replaced with corresponding configurations or features of another embodiment. It is apparent that claims not explicitly in a cited relationship in the claims may be combined to constitute an embodiment, or may be included as new claims through amendments after filing.

In this document, the embodiments of the present disclosure have been mainly described focusing on the signal transmission and reception relationship between the UE and the BS. The transmission and reception relationship may be identically or similarly extended to the signal transmission and reception between the UE and the relay, or between the BS and the relay. Specific operations described herein as being performed by the BS may, in some cases, be performed by the upper node. That is, in a network composed of a plurality of network nodes including the BS, various operations performed for communication with the UE may be performed by the BS or by other network nodes different from the BS. The term “base station” may be replaced with terms such as fixed station, Node B, eNode B (eNB), or access point. Similarly, the term “terminal” may be replaced with terms such as user equipment (UE), mobile station (MS), or mobile subscriber station (MSS).

The embodiments of the present disclosure may be implemented by various means, for example, hardware, firmware, software, or a combination thereof. In the case of implementation by hardware, the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, or microprocessors.

In the case of implementation by firmware or software, the embodiments of the present disclosure may be implemented in the form of modules, procedures, functions, or the like for performing the functions or operations described above. The software code may be stored in a memory unit and driven by a processor. The memory unit may be located inside or outside the processor, and may exchange data with the processor by various means already known.

It will be apparent to those skilled in the art that the present disclosure may be embodied in other specific forms without departing from the features of the present disclosure. Therefore, the above detailed description should not be construed as restrictive in all aspects but should be considered illustrative. The scope of the present disclosure should be determined by a reasonable interpretation of the appended claims, and all modifications within the equivalent scope of the present disclosure are included in the scope of the present disclosure.

### INDUSTRIAL APPLICABILITY

The above-described implementations of the present disclosure are applicable to various mobile communication systems.

1. A method by a first user equipment (UE) comprising:
receiving configuration information configuring a first threshold for a direct path directly connected to a base station (BS) and a second threshold for an indirect path connected to the BS via a second UE; and
triggering a measurement report related to release of the direct path based on the first threshold and the second threshold,
wherein the configuration information configures at least one of the first threshold or the second threshold differently based on a height of the first UE.

2. The method of claim 1, wherein the measurement report is triggered based on a signal strength of the direct path less than the first threshold and a signal strength of the indirect path greater than or equal to the second threshold.

3. The method of claim 1, wherein the configuration information configures the first threshold to increase as the height of the first UE increases.

4. The method of claim 1, wherein the configuration information configures the second threshold to decrease as the height of the first UE increases.

5. The method of claim 1, wherein the measurement report further includes indication information indicating that the measurement report is for releasing the direct path without changing the direct path.

6. The method of claim 1, further comprising receiving a message including a configuration for releasing the direct path.

7. The method of claim 1, wherein the configuration information further sets at least one height range related to a measurement of the measurement report, and
wherein the measurement report further includes identification information about a height range where the measurement is performed among the at least one height range.

8. The method of claim 7, wherein the measurement is performed independently in each of the at least one height range.

9. The method of claim 1, wherein the measurement report is reported via the indirect path.

10. The method of claim 1, wherein the first UE is an unmanned aerial vehicle (UAV) remote UE, and the second UE is a UAV relay UE.

11. (canceled)

12. A first user equipment (UE) comprising:
a radio frequency (RF) transceiver; and
a processor connected to the RF transceiver,
wherein the processor controls the RF transceiver to receive configuration information configuring a first threshold for a direct path directly connected to a base station (BS) and a second threshold for an indirect path connected to the BS via a second UE, and triggers a measurement report related to release of the direct path based on the first threshold and the second threshold, and
wherein the configuration information configures at least one of the first threshold or the second threshold differently based on a height of the first UE.

13. (canceled)

14. A method by a base station (BS) comprising:
transmitting configuration information configuring a first threshold for a direct path directly connected to the first UE and a second threshold for an indirect path connected to the first UE via a second UE; and
receiving a measurement report related to release of the direct path, triggered based on the first threshold and the second threshold,
wherein the configuration information configures at least one of the first threshold or the second threshold differently based on a height of the first UE.

15. (canceled)
